(19) United States
(12) Patent Application Publication
(10) Pub. No.: US 2024/0414520 A1
(43) Pub. Date: Dec. 12, 2024

(54) DYNAMICALLY ASSOCIATING MOBILE DEVICES WITH DIFFERENT LOGICAL NETWORKS IMPLEMENTED ON A SHARED NETWORK FABRIC OF A SINGLE ENTITY

(71) Applicant: VMware LLC, Palo Alto, CA (US)

(72) Inventor: Guang Lu, Beijing (CN)

(21) Appl. No.: 18/208,358

(22) Filed: Jun. 12, 2023

(51) Int. Cl. H04W 8/18; H04L 69/22; H04W 12/37; H04W 76/12

(52) U.S. Cl. CPC H04W 8/186; H04L 69/22; H04W 12/37; H04W 76/12; H04L 2212/00; H04W 92/02

(57) ABSTRACT

Some embodiments provide a novel method for dynamically associating mobile devices with different logical networks implemented on an entity's shared network fabric. At least two logical networks are implemented for at least two entity groups. At a first site, the method authenticates a mobile device and uses mobile device management (MDM) servers to identify an MDM group associated with the mobile device. The method uses the MDM group (1) to identify a first logical network over a shared network fabric at the first site to connect the mobile device to resources of the first site, and (2) to identify a logical network identifier (LNI) of a second logical network connecting a first edge gateway at the first site to a second edge gateway at a second site. The method inserts the LNI in an encapsulation header of data messages sent from the mobile device to resources at the second site.

### BACKGROUND

At different physical sites of an entity (e.g., a corporation), data message flows of users' endpoints (e.g., wired and wireless devices) are not dynamically isolated from other data message flows of other users' endpoints based on user identity, user role within the entity, and endpoint identity. Methods and systems are needed for isolating traffic between different users of a shared network fabric of an entity.

### BRIEF SUMMARY

Some embodiments provide a novel method for dynamically associating mobile devices with different software-defined wide area networks (SD-WANs) implemented for different user groups of a single shared network fabric of a single entity. The method identifies a particular mobile device that is trying to connect to a managed network switch. The method uses a set of one or more mobile device management (MDM) servers to identify a set of attributes associated with the particular mobile device attempting to access the shared network fabric. The method uses the identified set of attributes to identify an SD-WAN tenant identifier (ID) associated with a particular SD-WAN established for a group of devices including the particular mobile device. The method provides the SD-WAN tenant ID to the managed network switch to store in encapsulating headers that the managed network switch uses to encapsulate data message flows from the particular mobile device before forwarding the data message flows to one or more resources in the shared network fabric.

Some embodiments establish different SD-WANs for different user groups in order to isolate traffic between the different user groups. The managed network switch in some embodiments encapsulates different data message flows from different wired and wireless devices, including the particular mobile device, to forward the different data message flows to different resources in the shared network fabric. In some embodiments, the shared network fabric includes at least one of datacenter sites, branch sites, and cloud sites. The particular mobile device in some embodiments resides in a particular branch site of the shared network fabric. In some embodiments, the MDM server set resides in the particular branch site along with the particular mobile device. In these embodiments, the MDM server set performs operations for each mobile device in the particular branch site. In other embodiments, the MDM server set resides in a cloud site of the shared network fabric. In these embodiments, the MDM server set performs operations for mobile devices in one or more branch sites that do not include an MDM server set.

The method of some embodiments identifies the particular mobile device by identifying a media access control (MAC) address of the particular mobile device. In such embodiments, the method supplies the MAC address of the particular mobile device to the MDM server set in order to retrieve the set of attributes. In some embodiments, the set of attributes includes a user group ID associated with a particular user group to which the particular mobile device belongs. In such embodiments, the method supplies the MAC address of the particular mobile device to the MDM server set to identify the user group ID. The user group ID is in some embodiments further associated with a particular user of the particular mobile device.

In some embodiments, in identifying the particular mobile device, the method also identifies authentication credentials of a particular user of the particular mobile device. The authentication credentials in some embodiments include a username and password for the particular user. Unique usernames and passwords are associated with each user of the shared network fabric in order to authenticate each user. In some embodiments, before using the MDM server set to identify the set of attributes, the method authenticates the particular user using the username and password. In some embodiments, this is performed using an authentication server, which resides in the particular branch site or in the cloud site of the shared network fabric.

In some embodiments, the MDM server set maintains mappings between MAC addresses and user group IDs including a particular mapping between the MAC address of the particular mobile device and the user group ID associated with the particular user group to which the particular mobile device belongs. These mappings are stored in some embodiments in a local storage or memory of the MDM server set. The MDM server set in other embodiments associates the MAC address of the particular mobile device to the user group ID using a set of policies defined by a network administrator of the shared network fabric.

In some embodiments, the set of attributes also includes a user subgroup ID for a particular user subgroup of the particular user of the particular mobile device. In such embodiments, users are segmented into both groups and subgroups in order to further isolate traffic between users. The method of some embodiments uses the user subgroup ID to identify a virtual local area network (VLAN) tag for the particular user subgroup. This VLAN tag specifies a particular VLAN of the particular SD-WAN for the particular user subgroup.

The method of some embodiments provides, along with the SD-WAN tenant ID, the VLAN tag to the managed network switch to store in the encapsulating headers that the managed network switch uses to encapsulate the data message flows. In some embodiments, the managed network switch encapsulates the SD-WAN tenant ID and the VLAN tag in different encapsulating headers of the data message flows. In other embodiments, the managed network switch encapsulates the SD-WAN tenant ID and the VLAN tag in a same encapsulating header of the data message flows.

Some embodiments provide a novel method for dynamically associating mobile devices with different SD-WANs implemented on a shared network fabric of an entity. At least two different SD-WANs are implemented for at least two different groups of the entity. At a first site of the entity connected to a second site of the entity through the SD-WANs, the method identifies a particular mobile device that needs to connect to an SD-WAN. The method uses a set of one or more MDM servers to identify an MDM group with which the particular mobile device is associated. The method uses the identified MDM group to identify a particular local area network (LAN) at the first site for the particular mobile device to connect to network resources of the first site that are connected to the particular LAN. The method uses the identified MDM group to identify a particular SD-WAN for the particular mobile device to use to connect to a second site to have access to a set of one or more network resources at the second site.

In some embodiments, using the identified MDM group to identify the particular LAN at the first site for the particular mobile device to connect to the network resources of the first site includes inserting in a first encapsulating header, which is used to send a first set of encapsulated data messages between the particular mobile device and the network resources of the first site, a LAN identifier associated with the LAN. By encapsulating data messages sent between the particular mobile device and the network resources of the first site with the LAN identifier, the data messages will be sent through the LAN. In some embodiments, the LAN identifier is inserted into encapsulating headers by an SD-WAN edge appliance operating at the first site to forward the encapsulated data message flows to the network resources of the first site.

Using the identified MDM group to identify the particular SD-WAN for the particular mobile device to use to connect to the second site in some embodiments includes inserting in a second encapsulating header, which is used to send a second set of encapsulated data messages between the particular mobile device and the set of network resources at the second site, an SD-WAN identifier associated with the particular SD-WAN. By encapsulating data messages sent between the particular mobile device and the set of network resources at the second site with the SD-WAN identifier, the data messages will be sent through the SD-WAN. In some embodiments, the SD-WAN identifier is inserted into encapsulating headers by an SD-WAN edge appliance operating at the first site to forward the encapsulated data message flows to an orchestration service operating at the second site. In some embodiments, the LAN identifier is different from the SD-WAN identifier. In other embodiments, the LAN identifier and the SD-WAN identifier are the same identifier.

The method of some embodiments is performed by a set of software-defined edge network (SDEN) servers implementing an SDEN control plane at the first site. In such embodiments, an SDEN management plane operates in the second site along with an orchestration service (e.g., a VeloCloud® orchestration service) to connect to the first site. In some embodiments, the network resources include one or more of servers (e.g., virtual machines (VMs), containers, Pods, etc.), applications, middlebox services (e.g., firewall services, network address translation services, load balancing services, etc.), and forwarding elements (e.g., routers, switches, etc.).

At least two different SD-WANs are implemented for at least two different groups of the entity in some embodiments. These groups are in some embodiments different user groups of the entity. These groups in other embodiments are different device groups of the entity. The groups in other embodiments are a combination of user and device groups of the entity. The first site in some embodiments is a branch site of the entity, while the second site is a cloud site of the entity.

In some embodiments, the MDM group is identified by using the set of MDM servers to identify a device group to which the particular mobile device belongs. In such embodiments, the SDEN control plane provides the device's MAC address to the MDM server set to determine the device group. A device group is in some embodiments defined based on the device type, such as a first group for laptops, a second group for smartphones, a third group for tablets, etc.

In other embodiments, the SDEN control plane determines to which user group the user of the mobile device belongs. In such embodiments, the SDEN control plane provides the user's credentials to the MDM server set to determine the user group. The SDEN control plane of some embodiments also provides the device's MAC address along with the user's credentials to identify the user group. In some embodiments, a user group is a group of members of the entity that share a set of characteristics. The set of characteristics in some embodiments include at least one of a shared responsibility for the entity, a shared role within the entity, and a shared subgroup of the entity.

The particular LAN of some embodiments is a first logical network of several logical networks implemented at the first site for several different groups of mobile devices. These logical networks are implemented in some embodiments to isolate data message flows between the different groups.

Some embodiments provide a novel method for dynamically associating mobile devices with different logical networks implemented on a shared network fabric of an entity. At least two different logical networks are implemented for at least two different groups of the entity. At a first site of the entity, the method authenticates a particular mobile device. The method uses a set of one or more MDM servers to identify an MDM group with which the particular mobile device is associated. The method uses the identified MDM group to identify a first logical network that is defined over a shared network fabric at the first site for the particular mobile device to connect to network resources of the first site that are connected to the first logical network. The method uses the identified MDM group to identify a logical network identifier (LNI) associated with a second logical network connecting a first edge gateway at the first site to a second edge gateway at a second site of the entity. The method inserts the LNI in an encapsulation header that encapsulates data messages sent from the particular mobile device to a set of one or more network resources at the second site.

The second logical network identified by the LNI in some embodiments (1) spans the first and second sites and (2) connects the particular mobile device at the first site to the set of one or more network resources at the second site. In some embodiments, the encapsulation header is a tunnel header used to send the data messages from the first edge gateway to the second edge gateway through a tunnel established between the first and second edge gateways. This tunnel connects the first and second sites so that the particular mobile device is able to access the set of network resources at the second site. Because the data messages sent from the particular mobile device are sent using a secure connection (i.e., a tunnel), the particular mobile device can be seen as in the same overlay network as the set of network resources in the second site.

In some embodiments, the LNI is inserted into the encapsulating header by a tier-0 (T0) router operating at the first site to forward the encapsulated data messages to an edge node (or another T0 router) at the second site. The first logical network in some embodiments also has an associated LNI. In some embodiments, the first logical network LNI is the same as the second logical network LNI, as the first and second logical networks are one network. In other embodiments, the first logical network LNI is different than the second logical network LNI, as the first and second logical networks are two different logical networks with the first logical network being a logical local area network (LAN) and the second logical network being a logical wide area network (WAN). The logical LAN spans only the first site, while the logical WAN spans at least the first and second sites.

The encapsulation header used to send the data messages from the first edge gateway to the second edge gateway is in some embodiments a first tunnel header, and the data messages sent to the second site are in some embodiments a first set of data messages. In such embodiments, the method also inserts the first logical network LNI in a second encapsulation header that encapsulates a second set of data messages sent from the particular mobile device to the network resources of the first site. The second encapsulation header is also a tunnel header used to send the second set of data messages through a tunnel or a secure connection in some embodiments.

The method of some embodiments is performed by a set of SDEN servers implementing an SDEN control plane at the first site. In such embodiments, an SDEN management plane operates in the second site along with a software-defined network (SDN) management plane, an SDN control plane, and an SDN edge gateway to connect to the first site. In some embodiments, the network resources include one or more of servers (e.g., VMs, containers, Pods, etc.), applications, middlebox services (e.g., firewall services, network address translation services, load balancing services, etc.), and forwarding elements (e.g., routers, switches, etc.).

At least two different logical networks are implemented for at least two different groups of the entity in some embodiments. These groups are in some embodiments different user groups of the entity. These groups in other embodiments are different device groups of the entity. The groups in other embodiments are a combination of user and device groups of the entity. The first site in some embodiments is a branch site of the entity, while the second site is a cloud site of the entity.

In some embodiments, the particular mobile device is authenticated by receiving a set of authentication credentials from the particular mobile device and using the set of authentication credentials to authenticate the particular mobile device. The set of authentication credentials in some embodiments includes a username and password of a user of the particular mobile device. In some embodiments, the method directs an authentication server operating at the first site to authenticate the particular mobile device. In other embodiments, the method directs an authentication server operating at the second site to authenticate the particular mobile device by providing the set of authentication credentials to the authentication server.

In some embodiments, the MDM group is identified by using the set of MDM servers to identify a device group to which the particular mobile device belongs. In such embodiments, the SDEN control plane provides the device's MAC address to the MDM server set to determine the device group. A device group is in some embodiments defined based on the device type, such as a first group for laptops, a second group for smartphones, a third group for tablets, etc. In other embodiments, the SDEN control plane determines to which user group the user of the mobile device belongs. In such embodiments, the SDEN control plane provides the user's credentials to the MDM server set to determine the user group. The SDEN control plane of some embodiments also provides the device's MAC address along with the user's credentials to identify the user group.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, the Drawings, and the Claims is needed. Moreover, the claimed subject matters are not to be limited by the illustrative details in the Summary, Detailed Description, and Drawings.

### BRIEF DESCRIPTION OF THE DRAWINGS

The novel features of the invention are set forth in the appended claims. However, for purposes of explanation, several embodiments of the invention are set forth in the following figures.

FIG. 1 illustrates a shared network fabric used by several users of a single entity to implement one or more SD-WANs for different user groups.

FIG. 2 conceptually illustrates a process of some embodiments for dynamically associating mobile devices with different SD-WANs implemented for different user groups of a single shared network fabric of a single entity.

FIG. 3 illustrates an example embodiment of an SD-WAN for connecting multiple branch sites of a particular entity to each other and to a controller and at least one datacenter hub.

FIG. 4 illustrates a physical topology of an example branch site.

FIG. 5 illustrates a more detailed physical topology of an example branch site.

FIG. 6 illustrates a logical topology for implementing a branch site in some embodiments.

FIG. 7 illustrates communication for a branch site for wired devices.

FIG. 8 illustrates communication for a branch site for wireless devices.

FIG. 9 illustrates a detailed physical topology of an example remote site.

FIG. 10 illustrates a logical topology for implementing a remote site in some embodiments.

FIG. 11 illustrates communication for a remote site for wired devices.

FIG. 12 illustrates communication for a remote site for wireless devices.

FIG. 13 conceptually illustrates a process of some embodiments for dynamically associating mobile devices with different SD-WANs on a shared network fabric of an entity.

FIG. 14 conceptually illustrates a process of some embodiments for dynamically associating mobile devices with different logical networks implemented on a shared network fabric of an entity.

FIG. 15 conceptually illustrates an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a novel method for dynamically associating mobile devices with different software-defined wide area networks (SD-WANs) implemented for different user groups of a single shared network fabric of a single entity. The method identifies a particular mobile device that is trying to connect to a managed network switch. The method uses a set of one or more mobile device management (MDM) servers to identify a set of attributes associated with the particular mobile device attempting to access the shared network fabric. The method uses the identified set of attributes to identify an SD-WAN tenant identifier (ID) associated with a particular SD-WAN established for a group of devices including the particular mobile device. The method provides the SD-WAN tenant ID to the managed network switch to store in encapsulating headers that the managed network switch uses to encapsulate data message flows from the particular mobile device before forwarding the data message flows to one or more resources in the shared network fabric.

Some embodiments establish different SD-WANs for different user groups in order to isolate traffic between the different user groups. The managed network switch in some embodiments encapsulates different data message flows from different wired and wireless devices, including the particular mobile device, to forward the different data message flows to different resources in the shared network fabric. In some embodiments, the shared network fabric includes at least one of datacenter sites, branch sites, and cloud sites. The particular mobile device in some embodiments resides in a particular branch site of the shared network fabric. In some embodiments, the MDM server set resides in the particular branch site along with the particular mobile device. In these embodiments, the MDM server set performs operations for each mobile device in the particular branch site. In other embodiments, the MDM server set resides in a cloud site of the shared network fabric. In these embodiments, the MDM server set performs operations for mobile devices in one or more branch sites that do not include an MDM server set.

The method of some embodiments identifies the particular mobile device by identifying a media access control (MAC) address of the particular mobile device. In such embodiments, the method supplies the MAC address of the particular mobile device to the MDM server set in order to retrieve the set of attributes. In some embodiments, the set of attributes includes a user group ID associated with a particular user group to which the particular mobile device belongs. In such embodiments, the method supplies the MAC address of the particular mobile device to the MDM server set to identify the user group ID. The user group ID is in some embodiments further associated with a particular user of the particular mobile device.

In some embodiments, the set of attributes also includes a user subgroup ID for a particular user subgroup of the particular user of the particular mobile device. In such embodiments, users are segmented into both groups and subgroups in order to further isolate traffic between users. The method of some embodiments uses the user subgroup ID to identify a virtual local area network (VLAN) tag for the particular user subgroup. This VLAN tag specifies a particular VLAN of the particular SD-WAN for the particular user subgroup.

The method of some embodiments provides, along with the SD-WAN tenant ID, the VLAN tag to the managed network switch to store in the encapsulating headers that the managed network switch uses to encapsulate the data message flows. In some embodiments, the managed network switch encapsulates the SD-WAN tenant ID and the VLAN tag in different encapsulating headers of the data message flows. In other embodiments, the managed network switch encapsulates the SD-WAN tenant ID and the VLAN tag in a same encapsulating header of the data message flows.

Some embodiments provide a novel method for dynamically associating mobile devices with different SD-WANs implemented on a shared network fabric of an entity. At least two different SD-WANs are implemented for at least two different groups of the entity. At a first site of the entity connected to a second site of the entity through the SD-WANs, the method identifies a particular mobile device that needs to connect to an SD-WAN. The method uses a set of one or more MDM servers to identify an MDM group with which the particular mobile device is associated. The method uses the identified MDM group to identify a particular local area network (LAN) at the first site for the particular mobile device to connect to network resources of the first site that are connected to the particular LAN. The method uses the identified MDM group to identify a particular SD-WAN for the particular mobile device to use to connect to a second site to have access to a set of one or more network resources at the second site.

In some embodiments, using the identified MDM group to identify the particular LAN at the first site for the particular mobile device to connect to the network resources of the first site includes inserting in a first encapsulating header, which is used to send a first set of encapsulated data messages between the particular mobile device and the network resources of the first site, a LAN identifier associated with the LAN. By encapsulating data messages sent between the particular mobile device and the network resources of the first site with the LAN identifier, the data messages will be sent through the LAN. In some embodiments, the LAN identifier is inserted into encapsulating headers by an SD-WAN edge appliance operating at the first site to forward the encapsulated data message flows to the network resources of the first site.

Using the identified MDM group to identify the particular SD-WAN for the particular mobile device to use to connect to the second site in some embodiments includes inserting in a second encapsulating header, which is used to send a second set of encapsulated data messages between the particular mobile device and the set of network resources at the second site, an SD-WAN identifier associated with the particular SD-WAN. By encapsulating data messages sent between the particular mobile device and the set of network resources at the second site with the SD-WAN identifier, the data messages will be sent through the SD-WAN. In some embodiments, the SD-WAN identifier is inserted into encapsulating headers by an SD-WAN edge appliance operating at the first site to forward the encapsulated data message flows to an orchestration service operating at the second site. In some embodiments, the LAN identifier is different from the SD-WAN identifier. In other embodiments, the LAN identifier and the SD-WAN identifier are the same identifier.

The method of some embodiments is performed by a set of software-defined edge network (SDEN) servers implementing an SDEN control plane at the first site. In such embodiments, an SDEN management plane operates in the second site along with an orchestration service (e.g., a VeloCloud® orchestration service) to connect to the first site. In some embodiments, the network resources include one or more of servers (e.g., virtual machines (VMs), containers, Pods, etc.), applications, middlebox services (e.g., firewall services, network address translation services, load balancing services, etc.), and forwarding elements (e.g., routers, switches, etc.).

The particular LAN of some embodiments is a first logical network of several logical networks implemented at the first site for several different groups of mobile devices. These logical networks are implemented in some embodiments to isolate data message flows between the different groups.

Some embodiments provide a novel method for dynamically associating mobile devices with different logical networks implemented on a shared network fabric of an entity. At least two different logical networks are implemented for at least two different groups of the entity. At a first site of the entity, the method authenticates a particular mobile device. The method uses a set of one or more MDM servers to identify an MDM group with which the particular mobile device is associated. The method uses the identified MDM group to identify a first logical network that is defined over a shared network fabric at the first site for the particular mobile device to connect to network resources of the first site that are connected to the first logical network. The method uses the identified MDM group to identify a logical network identifier (LNI) associated with a second logical network connecting a first edge gateway at the first site to a second edge gateway at a second site of the entity. The method inserts the LNI in an encapsulation header that encapsulates data messages sent from the particular mobile device to a set of one or more network resources at the second site.

The second logical network identified by the LNI in some embodiments (1) spans the first and second sites and (2) connects the particular mobile device at the first site to the set of one or more network resources at the second site. In some embodiments, the encapsulation header is a tunnel header used to send the data messages from the first edge gateway to the second edge gateway through a tunnel established between the first and second edge gateways. This tunnel connects the first and second sites so that the particular mobile device is able to access the set of network resources at the second site. Because the data messages sent from the particular mobile device are sent using a secure connection (i.e., a tunnel), the particular mobile device can be seen as in the same overlay network as the set of network resources in the second site.

In some embodiments, the LNI is inserted into the encapsulating header by a tier-0 (T0) router operating at the first site to forward the encapsulated data messages to an edge node (or another TO router) at the second site. The first logical network in some embodiments also has an associated LNI. In some embodiments, the first logical network LNI is the same as the second logical network LNI, as the first and second logical networks are one network. In other embodiments, the first logical network LNI is different than the second logical network LNI, as the first and second logical networks are two different logical networks with the first logical network being a logical local area network (LAN) and the second logical network being a logical wide area network (WAN). The logical LAN spans only the first site, while the logical WAN spans at least the first and second sites.

The encapsulation header used to send the data messages from the first edge gateway to the second edge gateway is in some embodiments a first tunnel header, and the data messages sent to the second site are in some embodiments a first set of data messages. In such embodiments, the method also inserts the first logical network LNI in a second encapsulation header that encapsulates a second set of data messages sent from the particular mobile device to the network resources of the first site. The second encapsulation header is also a tunnel header used to send the second set of data messages through a tunnel or a secure connection in some embodiments.

The method of some embodiments is performed by a set of SDEN servers implementing an SDEN control plane at the first site. In such embodiments, an SDEN management plane operates in the second site along with a software-defined network (SDN) management plane, an SDN control plane, and an SDN edge gateway to connect to the first site. In some embodiments, the network resources include one or more of servers (e.g., VMs, containers, Pods, etc.), applications, middlebox services (e.g., firewall services, network address translation services, load balancing services, etc.), and forwarding elements (e.g., routers, switches, etc.).

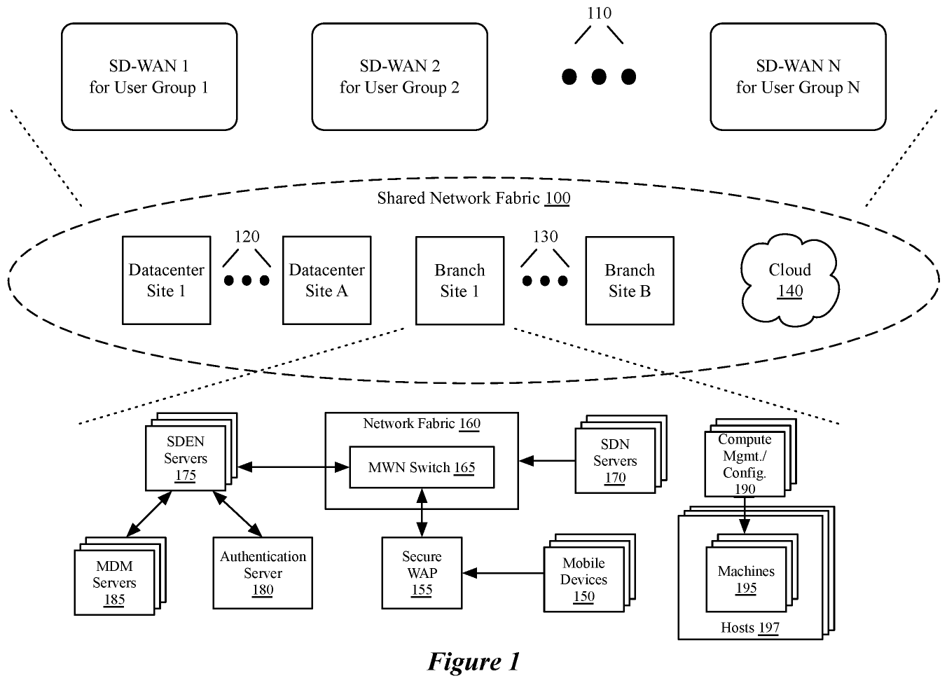

FIG. 1 illustrates a shared network fabric 100, used by several users of a single entity, to implement one or more SD-WANs 110 for different user groups. The shared network fabric 100 includes, in some embodiments, one or more datacenter sites 120, one or more branch sites 130, and a cloud 140. The datacenter sites 120 and branch sites 130 can each reside in a different geographic location (also referred to as a physical site).

The datacenter sites 120 and the branch sites 130 in some embodiments each include a set of resources, which may include servers, hosts, routers, switches, and/or other physical or logical elements (e.g., VM, containers, etc.). The resources may communicate with resources of other branches and/or other resources outside of their own site through forwarding elements (e.g., edge nodes, gateways, etc.). A datacenter forwarding node is referred to as a hub node because in some embodiments this forwarding node can be used to connect (e.g., through a virtual private network (VPN) tunnel) to other edge forwarding nodes of the branch sites 130. A hub node in some embodiments provides services (e.g., middlebox services) for data messages that it forwards from one branch site to another branch site. A hub node in some embodiments also provides access to the datacenter's resources.

In some embodiments, the cloud 140 spans each physical site of the datacenter sites 120 and branch sites 130. In this example, the shared network fabric 100 includes one cloud 140. However, in other embodiments, the shared network fabric 100 includes multiple clouds. The cloud 140 of some embodiments includes a set of one or more cloud resources, such as a cloud gateway (CGW). The CGW in some embodiments connects the datacenter sites 120 and branch sites 130 (e.g., using VPN tunnels).

In some embodiments, one branch site 130 includes a set of one or more mobile devices 150, a secure wireless access point (WAP) 155, a network fabric 160 including a managed wireless network (MWN) switch 165, a set of one or more SDN servers 170, a set of one or more SDEN servers 175, an authentication server 180, a set of one or more mobile device management (MDM) servers 185, a set of compute management/configuration servers 190, and a set of one or more machines 195 executing on a set of one or more host computers 197. Each branch site 130 can include any number of each of these components. In other embodiments, different branch sites include at least a subset of the components 150-197. The compute management/configuration server set 190 in some embodiments manages and configures the machines 195 executing on the hosts 197. The machines 195 can include one or more of VMs, containers, pods, etc.

In some embodiments, the SDN server set 170 includes one or more managers and/or one or more controllers responsible for configuring the network fabric 160 of the branch site, including the managed wireless network switch 165. The managed wireless network switch 165 is in some embodiments a hardware switch, and, in other embodiments, is a software or virtual switch. In some embodiments, it is a wired switch connected by a physical link to the secure WAP 155. In other embodiments, it is a wireless switch connected, e.g., by a secure tunnel, to the secure WAP 155.

The shared network fabric 100 is used by several users of a single entity. For example, the shared network fabric 100 in some embodiments is used by employees of a single enterprise or corporation. In order to isolate traffic of different user groups (e.g., of different departments of the corporation), the shared network fabric 100 in some embodiments implements a different SD-WAN 110 for each user group that uses the shared network fabric 100. Any number of SD-WANs may be created for any number of user groups. In some embodiments, one SD-WAN is created for each user group. In other embodiments, at least one user group has multiple SD-WANs created for it.

In some embodiments, each device of each user in a user group is associated with a tenant identifier (ID). For instance, each device associated with a first SD-WAN is associated with a first set of one or more tenant IDs for the first SD-WAN, while each device associated with a second SD-WAN is associated with a second set of one or more tenant IDs for the second SD-WAN. In some embodiments, each user and each device for a particular user group is associated with the same tenant ID for the SD-WAN of the user group. In other embodiments, different tenant IDs are associated with the different users, meaning that all devices of a particular user are associated with a user-specific tenant ID for the SD-WAN of the user group. Still, in other embodiments, different tenant IDs are associated with different types of devices, meaning that each different type of device (e.g., desktop computer, laptop computer, mobile phone, etc.) of one user is associated with a different tenant ID for one SD-WAN of the user group. In such embodiments, the same type of device for different users is associated with the same tenant ID in some embodiments, while, in other embodiments, same-type devices of different users are associated with different tenant IDs.

To associate user devices with an SD-WAN, some embodiments use a set of SDEN servers 175. As shown, the SDEN server set 175 of some embodiments is deployed in a branch site 130. An SDEN server set 175 of some embodiments allows for users of the shared network fabric 100 to be automatically recognized based on user and/or device identity and added to the correct SD-WAN. For example, a mobile device 150 sends a request to access the shared network fabric 100 to the secure WAP 155. The secure WAP 155 verifies a signature of the mobile device 150. In some embodiments, the secure WAP 155 verifies the signature of a particular application used by the mobile device to provide user credentials (e.g., a username and password). Once the secure WAP 155 verifies the mobile device's signature, the secure WAP 155 instantiates a secure (e.g., encrypted) channel between the secure WAP 155 and the mobile device 150 to collect user attributes, such as the user's ID, a password, and/or a media access control (MAC) address of the mobile device. In some embodiments, the collected MAC address is the source MAC address of the mobile device 150.

Then, the secure WAP 155 sends the collected user attributes to the SDEN server set 175 through the managed wireless network switch 165. Using the user's attributes, the SDEN server set 175 authenticates the user using the authentication server 180. In some embodiments, the authentication server 180 is a Remote Authentication Dial-In User Service (RADIUS) server. Once the user has been authenticated, the SDEN server set 175 supplies the collected user attributes (e.g., the user ID and/or MAC address) to the MDM server set 185. In some embodiments, an MDM server set is deployed in each branch site 130. In other embodiments, one MDM server set is deployed in the cloud 140 for each branch site 130. Still, in other embodiments, a subset of branch sites deploy their own MDM server set, while another subset of branch sites use an MDM server set in the cloud 140.

The MDM server set 185 in some embodiments provides one or more MDM attributes for the mobile device 150, the user (of the mobile device), and/or application (executing on the mobile device) requesting access to the shared network fabric 100. The MDM server set 185 in some embodiments is the server set that also provisions mobile devices for accessing the resources of the shared network fabric 100. Provisioning in different embodiments involves different combinations of the following operations: (1) adding the mobile device's identifier to a list of mobile devices that can have remote access, (2) adding a user identifier to identify one or more users that can have remote access through the mobile device, (3) providing VPN access software and/or settings to the mobile device so that the mobile device can set up secure VPN remote access with the datacenter, and (4) defining tenant information, like corporation identifier, user entitlements, etc.

After receiving the user attributes, the MDM server set 185 of some embodiments determines one or more user group attributes of a particular user group to which the user of the mobile device 150 belongs. In some embodiments, the MDM server set 185 maintains mappings between user attributes and user group attributes. The MDM server set 185 of some embodiments maintains mappings between MAC addresses of devices 150 and user group IDs. These mappings are stored in a local storage or memory of the MDM server set 185, in some embodiments. The MDM server set 185 of some embodiments associates user attributes (e.g., MAC addresses) to user group attributes (e.g., user group IDs) using a set of policies defined by a network administrator of the shared network fabric 100.

The SDEN server set 175 receives one or more user group attributes from the MDM server set 185. For example, the SDEN server set 175 of some embodiments receives a user group ID corresponding to the particular department of the corporation to which the user of the mobile device 150 belongs. Using the obtained user group attributes, the SDEN server set 175 identifies a tenant ID for the user and/or the user group. This tenant ID specifies which SD-WAN 110 the user should be placed. After identifying the tenant ID, the SDEN server set 175 provides the SD-WAN tenant ID to the managed wireless network switch 165. Then, the managed wireless network switch 165 encapsulates communications sent from the mobile device 150 through the secure WAP 155 with the tenant ID (e.g., in an encapsulating header) to forward to other resources in the branch site 130, a datacenter site 120, other branch sites, or the cloud 140.

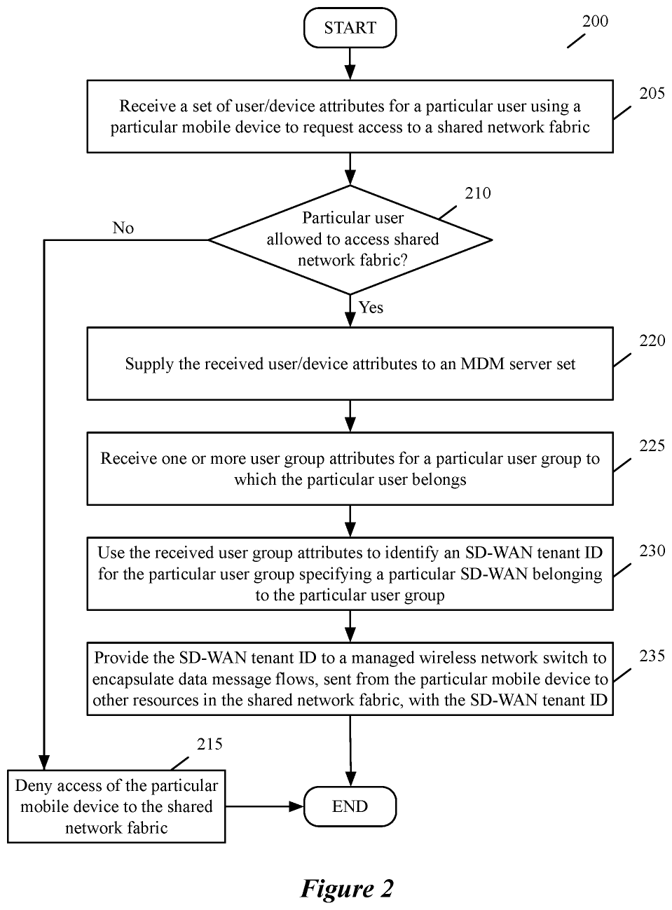

FIG. 2 conceptually illustrates a process 200 of some embodiments for dynamically associating mobile devices with different SD-WANs implemented for different user groups of a single shared network fabric of a single entity (e.g., a corporation). The process 200 of some embodiments is performed by a set of one or more SDEN severs operating in a branch site for a particular mobile device at the branch site. In some embodiments, the process 200 is performed after a secure WAP has received a request for access to a shared network fabric from the particular mobile device, and collected user and/or device attributes from the particular mobile device, such as a MAC address of the particular mobile device and a username and password of a particular user using the particular mobile device.

The process 200 begins by receiving (at 205) a set of user/device attributes for the particular user using the particular mobile device to request access to a shared network fabric of an entity. In some embodiments, the SDEN server set receives a MAC address of the particular mobile device, and authentication credentials (e.g., a username and password) for the particular user from a managed wireless network switch in the branch site. The managed wireless network switch in some embodiments receives these attributes from a secure WAP that enables communication between the particular mobile device and the managed wireless network switch.

Next, the process 200 determines (at 210) whether the particular user is allowed to access the shared network fabric. In some embodiments, the shared network fabric is only able to be accessed by authorized users (i.e., employees or authorized guests) of the corporation. In such embodiments, the SDEN server set uses an authentication server (e.g., a RADIUS server) to authenticate the user's authentication credentials. If the process 200 determines that the particular user is not allowed to access the shared network fabric, the process 200 denies (at 215) access of the particular mobile device to the shared network fabric, and the process 200 ends. In some embodiments, the SDEN server set sends a notification of access denial to the managed wireless network switch, which provides the notification to the particular mobile device through the secure WAP.

If the process 200 determines that the particular user is allowed to access the shared network fabric, the process 200 supplies (at 220) the received user/device attributes to an MDM server set. In some embodiments, the MDM server set resides in the same branch site as the SDEN server set and the particular mobile device. In other embodiments, the MDM server set resides in a cloud site of the shared network fabric. The SDEN server set of some embodiments provides the particular mobile device's MAC address to the MDM server set in order to determine the user group to which the particular user group belongs. In other embodiments, the SDEN server set also provides the particular user's authentication credentials to determine the user group.

At 225, the process 200 receives one or more user group attributes for a particular user group to which the particular user belongs. The SDEN server set receives, from the MDM server set, an ID corresponding to the user group (e.g., the department of the corporation) to which the particular user belongs. In some embodiments, the MDM server set maintains a mapping table mapping device MAC addresses to user group IDs. For example, if the particular mobile device belonging to the particular user is part of a finance department of the corporation, the MDM server set maintains a mapping between the particular mobile device's MAC address and an ID identifying the finance department.

After receiving the one or more user group attributes, the process 200 uses (at 230) the received user group attributes to identify an SD-WAN tenant ID for the particular user group specifying a particular SD-WAN belonging to the particular user group. After receiving identification of the particular user's user group, the SDEN server set identifies the SD-WAN for the user group by identifying a tenant ID for the user group. In some embodiments, the same tenant ID is used for all users of the user group. In other embodiments, a set of tenant IDs is used for the user group such that at least two different users of the user group have their own unique tenant ID.

Lastly, the process 200 provides (at 235) the identified SD-WAN tenant ID to the managed wireless network switch to encapsulate data message flows, sent from the particular mobile device to other resources in the shared network fabric, with the SD-WAN tenant ID. After identifying the SD-WAN tenant ID for the particular user group (and, therefore, for the particular user), the SDEN server set provides it to the managed wireless network switch. The managed wireless network switch of some embodiments encapsulates each data message sent from the particular mobile device with an encapsulating header that includes the SD-WAN tenant ID so that all data message flows sent by the particular mobile device are sent through the correct SD-WAN.

In some embodiments, the managed wireless network switch stores the SD-WAN tenant ID in a local storage or memory. For example, the managed wireless network switch of some embodiments maintains, in a local storage, a mapping table that includes mappings between each mobile device it exchanges data message flows for and the tenant ID associated with each mobile device. After providing the SD-WAN tenant ID to the managed wireless network switch, the process 200 ends.

In some embodiments, a mobile device requesting access to a shared network fabric does not belong to a user group with an already established SD-WAN. In such embodiments, the SDEN server set creates a new SD-WAN tenant ID for the user group to create a new SD-WAN for the group. In other embodiments, the mobile device does not belong to any user group. In these embodiments, the MDM server set creates a new user group ID for the user and sends the new user group ID to the SDEN server set. Then, the SDEN server set creates a new SD-WAN tenant ID for the new user group ID to establish a new SD-WAN for the new user group.

In addition to dynamically associating mobile devices with different SD-WANs implemented for different user groups of a single shared network fabric of a single entity, some embodiments associate mobile devices with different virtual local area networks (VLANs) within each SD-WAN for different user subgroups of the shared network fabric in order to further segment each SD-WAN. In such embodiments, the SDEN server set receives, from the MDM server set, (1) user group attributes in order to determine the correct SD-WAN and (2) user subgroup attributes in order to determine the correct VLAN of the SD-WAN.

Using the user group attributes, the SDEN server set determines an SD-WAN tenant ID for the user group. Using the user subgroup attributes, the SDEN server set determines a VLAN tag for the user subgroup. In some embodiments, the SDEN server set also determines an Internet Protocol (IP) subnet for the user subgroup and assigns an IP address from that subnet to the mobile device. Then, the SDEN server set provides the SD-WAN tenant ID, the VLAN tag, and the assigned IP address to the managed wireless network switch for forwarding flows sent from the mobile device to other resources. In some embodiments, the managed wireless network switch places both the tenant ID and VLAN tag in a single encapsulating header of each data message sent from the mobile device. In other embodiments, the managed wireless network switch places the tenant ID and VLAN tag in separate encapsulating headers of each data message sent from the mobile device. Even as the mobile device moves to different branch sites and to different physical locations, the assigned SD-WAN tenant ID, VLAN tag, and IP subnet remains the same.

As discussed previously, different user groups of an entity (e.g., a corporation) are associated with different SD-WANs of a shared network fabric in order to isolate traffic between each user group. An SD-WAN can include any number of branch sites, datacenter sites, and cloud sites of the shared network fabric. Different SD-WANs in some embodiments include different sites located in different geographic locations. For example, a first SD-WAN for an engineering department of some embodiments includes sites in a first set of geographic locations, while a second SD-WAN for a legal department includes sites in a second set of geographic locations. The first and second sets of geographic locations in some embodiments include at least one same geographic site.

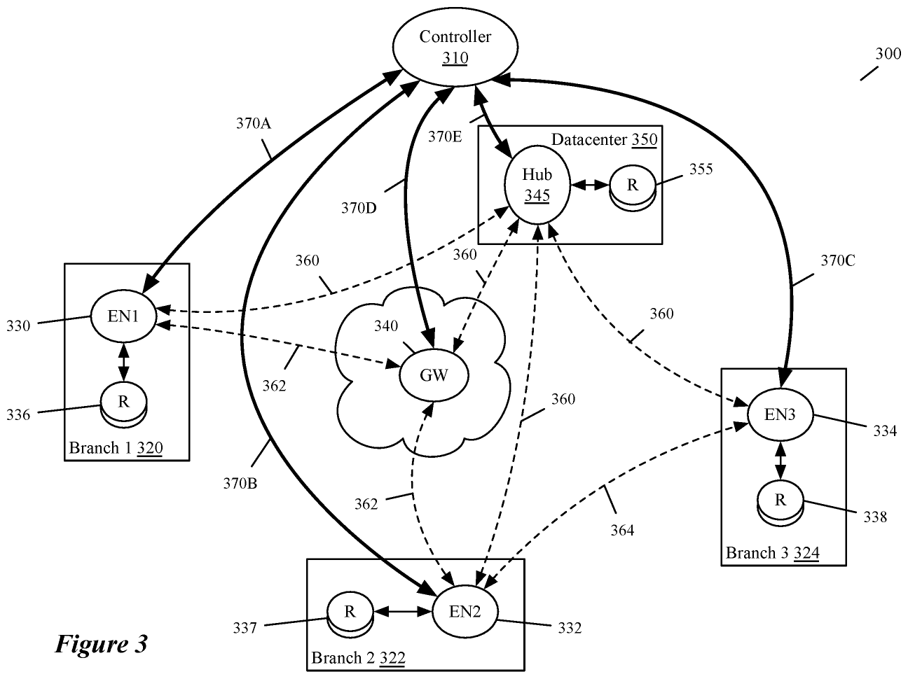

FIG. 3 illustrates an example embodiment of an SD-WAN 300 (also referred to herein as a virtual network) for connecting multiple branch sites of a particular entity to each other and to a controller and at least one datacenter hub. As shown, the SD-WAN 300 includes a controller 310, three branch sites 320-324 that each include an edge forwarding node 330-334 (also referred herein as edge nodes or nodes) and resources 336-338, a cloud gateway 340, and a datacenter 350 with a hub 345.

The edge nodes in some embodiments are edge machines (e.g., VMs, containers, programs executing on computers, etc.) and/or standalone appliances that operate at multi-computer locations of the particular entity (e.g., at an office or datacenter of the entity) to connect the computers at their respective locations to other nodes, hubs, etc. in the virtual network. In some embodiments, the edge nodes are clusters of nodes at each of the branch sites. In other embodiments, the edge nodes are deployed to each of the branch sites as high-availability pairs such that one edge node in the pair is the active node and the other edge node in the pair is the standby node that can take over as the active edge node in case of failover.

Each edge node 330-334 in some embodiments includes one or more of edge appliances, broadband routers, and customer edge (CE) routers. In such embodiments, each edge node includes multiple components, and connects to each other site (branch sites, 320-324, datacenter 350, and cloud gateway 340) through one or more links. These multiple links in some embodiments include LAN links connecting to resources within the branch site and/or WAN links connecting to the other sites.

In some embodiments, each edge node, hub, and cloud gateway in an SD-WAN (such as the edge nodes 330-334, the datacenter hub 345, and the cloud gateway 340 of the SD-WAN 300) includes a router that performs the data message forwarding operations of the edge node, hub, or cloud gateway. In such embodiments, the next-hop forwarding records of these edge nodes, hubs, and cloud gateways are routing records used by the routers to forward data messages through the SD-WAN.

Each edge node 330-334 in some embodiments connects to an external network through two or more forwarding devices (e.g., an MPLS (multiprotocol label switching) device, a cable modem router, a 5G router) of two or more communication service providers (e.g., a telephone company provider of an MPLS network, a cable modem provider of an ISP (Internet Service Provider), a wireless provider for the 5G connectivity). In some of these embodiments, each edge node 330-334 connects to the forwarding devices of the service providers through two or more physical ports of the edge node.

An example of an entity for which such a virtual network can be established includes a business entity (e.g., a corporation), a non-profit entity (e.g., a hospital, a research organization, etc.), an education entity (e.g., a university, a college, etc.), or any other type of entity. In some embodiments, multiple virtual networks are established for a single entity. For example, for a business entity in some embodiments, a first SD-WAN is established for an engineering department of the business entity, a second SD-WAN is established for a finance department of the business entity, a third SD-WAN is established for a legal department of the business entity, etc. In some embodiments, each of these different SD-WANs differs from each other.

For example, the first SD-WAN for the engineering department in some embodiments connects two of the business entity's branch sites and a datacenter site (i.e., the first SD-WAN includes the edge nodes of the two branch sites along with the cloud gateway and the datacenter hub), while the second SD-WAN for the finance department connects all of the business entity's branch sites and not the datacenter site (i.e., the SD-WAN includes the edge nodes of all branch sites along with the cloud gateway). In such embodiments, when a wireless device used by a particular user belonging to a particular department requests to connect to an SD-WAN of the business entity, the wireless device is placed in the correct SD-WAN corresponding to the user's particular department.

Examples of public cloud providers include Amazon Web Services® (AWS), Google Cloud Platform™ (GCP), Microsoft Azure®, etc., while examples of entities include a company (e.g., corporation, partnership, etc.), an organization (e.g., a school, a non-profit, a government entity, etc.), etc. In other embodiments, hubs like the hub 345 can also be deployed in private cloud datacenters of a virtual WAN provider that hosts hubs to establish SD-WANs for different entities.

In the example SD-WAN 300, the hub 345 is a multi-tenant forwarding element that is deployed on the premises of the datacenter 350. The hub 345 can be used to establish secure connection links (e.g., tunnels) with edge nodes at the particular entity's multi-computer sites, such as branch sites 320-324, third-party datacenters (not shown), etc. For example, the hub 345 can be used to provide access from each branch site 320-324 to each other branch site 320-324 (e.g., via the connection links 360 that terminate at the hub 345) as well as to the resources 355 of the datacenter 350. These multi-computer sites are often at different physical locations (e.g., different buildings, different cities, different states, etc.), according to some embodiments. In some embodiments, hubs can be deployed as physical nodes or virtual nodes. Additionally, hubs in some embodiments can be deployed on a cloud (e.g., as a set of virtual edges configured as a cluster).

In the SD-WAN 300, the hub 345 also provides access to the resources 355 of the datacenter 350 as mentioned above. The resources 355 in the datacenter 350 and the resources 336-338 in the branch sites 320-324 in some embodiments include a set of one or more servers (e.g., web servers, database servers, etc.) within a microservices container (e.g., a pod). Conjunctively, or alternatively, some embodiments include multiple such microservices containers, each accessible through a different set of one or more hubs of the datacenter (not shown). The resources, as well as the hubs, are within the datacenter premises, according to some embodiments. While not shown, some embodiments include multiple different Software-as-a-Service (SaaS) datacenters, which may each be accessed via different sets of hubs, according to some embodiments. In some embodiments, the SaaS datacenters include datacenters for video conferencing SaaS providers, for middlebox (e.g., firewall) service providers, for storage service providers, etc.

Additional examples of resources 355 in the datacenter 350 and resources 336-338 in the branch sites 320-324, in some embodiments, include compute machines (e.g., virtual machines and/or containers providing server operations), storage machines (e.g., database servers), and middlebox service operations (e.g., firewall services, load balancing services, encryption services, etc.). Within each branch site 320-324, edge nodes in some embodiments connect to their resources using links, which are the LANs within the branch site. In some embodiments, the connections 360 between the branch sites 320-324 and the hub 345 are secure encrypted connections that encrypt data messages exchanged between the edge nodes 330-334 of the branch sites 320-324 and the hub 345. Examples of secure encrypted connections used in some embodiments include VPN (virtual private network) connections, or secure IPsec (Internet Protocol security) connections.

In some embodiments, multiple secure connection links (e.g., multiple secure tunnels) can be established between an edge node and the hub 345. When multiple such links are defined between a node and a hub, each secure connection link, in some embodiments, is associated with a different physical network link between the node and an external network. For instance, to access external networks in some embodiments, a node has one or more commercial broadband Internet links (e.g., a cable mode and a fiber optic link) to access the Internet, a wireless cellular link (e.g., a 5G LTE network), etc. The collection of the edge nodes, gateway, datacenter hub, controller, and secure connections between the edge nodes, gateway, datacenter hub, and controller form the SD-WAN 300.

The controller 310 of some embodiments communicates with each of the nodes 330-334 at the branch sites 320-324 to assign a tenant ID to the SD-WAN 300. While illustrated as individual connection links, the links 370A-370E are sets of multiple connection links, according to some embodiments. In addition to the connection links 370A-370E and 360, edge nodes 332 and 334 are connected via connection link 364, while edge nodes 330 and 332 are connected to the gateway 340 via connection links 362. The gateway 340 in this example is responsible for relaying information between edge nodes (e.g., edge nodes 330 and 332, which do not share a direct connection). Also, the gateway 340 in some embodiments is used to set up direct edge-to-edge connections. In some embodiments, the gateway 340 can be used to provide the edge nodes with access to cloud resources (e.g., compute, storage, and service resources of a cloud datacenter).

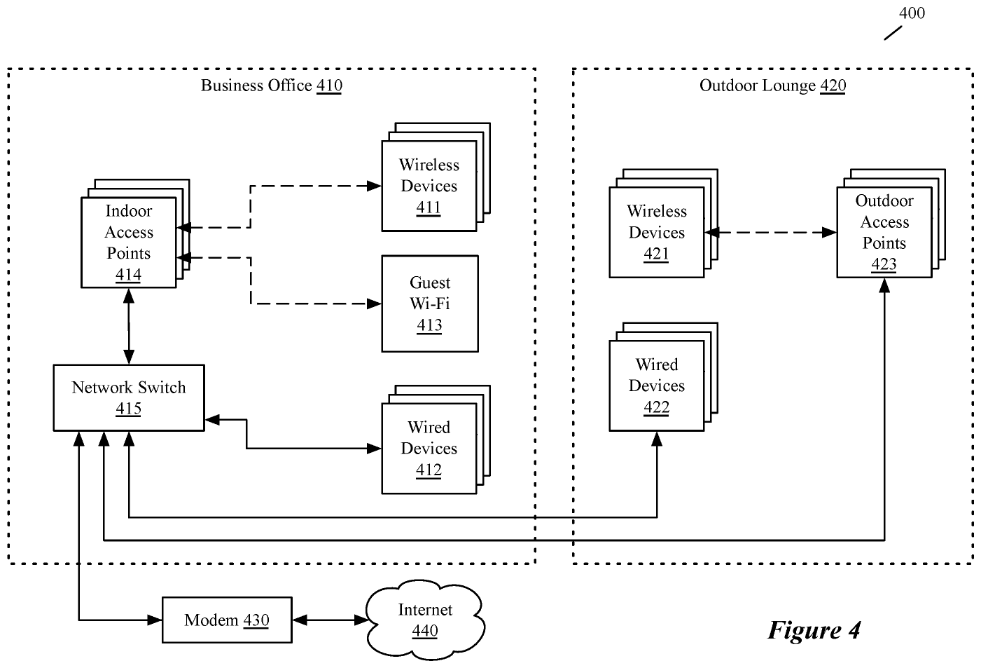

FIG. 4 illustrates an example branch office 400 and its physical components. In this example, the branch office 400 includes a business office 410 and an outdoor lounge 420. The branch office 410 includes wireless devices 411, wired devices 412, guest Wi-Fi 413, one or more indoor access points 414, and a network switch 415. The outdoor lounge 420 includes wireless devices 421, wired devices 422, and outdoor access points 423.

The wireless devices 411 and 421 in some embodiments include wireless mobile devices of users in the branch office 400, such as laptops, mobile phones, tablets, etc. The wireless devices 411 and 421 also include, in some embodiments, shared wireless devices, such as a thermostat for the business office 410. In some embodiments, the wired devices 412 inside the business office 410 include devices used by individual users in the branch office 400, such as desktop computers. The wired devices 412 in some embodiments include wired devices used by one or more users inside the business office 410, such as servers, printers, televisions, projectors, and desk phones. The wired devices 422 in the outdoor lounge 420 in some embodiments include wired devices used by one or more users in the outdoor lounge 420, such as security cameras.

The wireless devices 411 inside the business office 410 connect to one or more indoor access points 414. In some embodiments, all wireless devices 411 connect to the same indoor access point. In other embodiments, a first subset of the wireless devices 411 connect to a first indoor access point, while a second subset of the wireless devices 411 connect to a second indoor access point. The guest Wi-Fi 413 also connects to one of the indoor access points 414. By connecting to the indoor access points 414, the wireless devices 411 and guest Wi-Fi 413 can communicate with the network switch 415.

The wired devices 412 of some embodiments connect directly to the network switch 415. The network switch 415 connects to a modem 430 in order to connect to the Internet 440. The network switch 415 allows the wireless devices 411, wired devices 412, and guest Wi-Fi 413 to exchange data message flows with other branch sites through the Internet 440.

The wireless devices 421 out in the outdoor lounge 420 connect to one or more outdoor access points 423. In some embodiments, all wireless devices 421 connect to the same outdoor access point. In other embodiments, a first subset of the wireless devices 421 connect to a first outdoor access point, while a second subset of the wireless devices 421 connect to a second outdoor access point. By connecting to the outdoor access points 423, the wireless devices 421 can communicate with the network switch 415. The wired devices 422 of some embodiments connect directly to the network switch 415. The network switch 415 allows the wireless devices 421 and wired devices 422 to exchange data message flows with other branch sites through the Internet 440.

All of the wireless devices 411 and 421 and the wired devices 412 and 422 are in some embodiments part of one or more SD-WANs established for the branch office's entity. For instance, a first wireless device of the business office wireless devices 411 is in some embodiments part of a first SD-WAN, while a second wireless device of the business office wireless devices 411 is part of a second SD-WAN. While both devices reside in the same physical location (i.e., the same branch site 400), they may be in different virtual networks based on the identity of the user using that device.

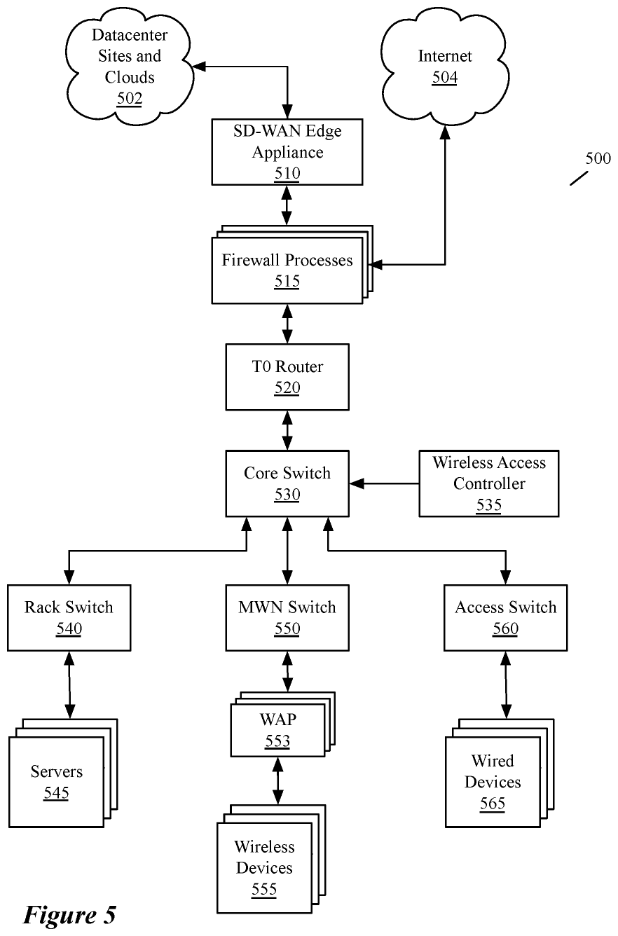

FIG. 5 illustrates another example branch site 500 with a more detailed physical topology. In this example, the branch site 500 communicates with one or more datacenter sites and one or more cloud sites 502 through an SD-WAN edge appliance 510. In some embodiments, the SD-WAN edge appliance 510 operates as a standalone computer. In other embodiments, it runs as a software edge node on a host computer in the branch site 500. In some embodiments, the SD-WAN edge appliance 510 includes a router that performs the data message forwarding operations of the SD-WAN edge appliance. In such embodiments, the next-hop forwarding records of the SD-WAN edge appliance 510 are routing records used by the router to forward data messages to the datacenter sites and clouds 502.

In some embodiments, the SD-WAN edge appliance 510 includes two or more edge devices, with each edge device connected to the datacenter sites and clouds 502 through different communication service providers (e.g., an MPLS device, a cable modem router, a 5G router, etc.). In some of these embodiments, the edge devices of the SD-WAN edge appliance 510 connect to each other using a physical cable link.

The branch site 500 also communicates with the Internet 504. Data message flows received from the datacenter sites and cloud sites 502 (through the SD-WAN edge appliance 510) and the Internet 504 are sent through one or more firewall processes 515. In some embodiments, one or more cloud sites 502 include one or more MDM servers (not shown) for use by the branch site 500.

After being processed by the firewall processes 515, allowed data message flows are sent to a Tier-0 (T0) router 520 of the branch site 500, and then to a core switch 530. The core switch 530 is connected to a wireless access controller 535. In some embodiments, the wireless access controller 535 configures the WAP 553 and controls policies used by the WAP 553. In such embodiments, the wireless access controller 535 sends WAP policies to the WAP 553 through the core switch 530. Any number of WAPs may execute in the branch site 500.

The core switch 530 connects to a rack switch 540, a managed wireless network switch 550, and an access switch 560 that connect to different types of endpoints in the branch site 500 and are configured by SDN servers (e.g., SDN managers and controllers) (not shown) operating at the branch site 500. The rack switch 540 connects to one or more servers 545. The managed wireless network switch 550 connects to a WAP 553, which provides communication between the managed wireless network switch 550 and wireless devices 555 at the branch site 500. The access switch 560 is a managed wired network switch (i.e., a switch that is managed by a set of SDN managers and controllers and that has physical ports for receiving Ethernet cables) that connects to the wired devices 565 at the branch site 500. The core switch 530 enables all endpoints 545, 555, and 565 to exchange data message flows with each other and with resources outside the branch site 500 (e.g., resources residing at the datacenter sites and clouds 502 and resources reachable over the Internet 504).

All of the wireless devices 555 and the wired devices 565 are in some embodiments part of one or more SD-WANs established for the branch office's entity. For instance, a first wireless device is in some embodiments part of a first SD-WAN, while a second wireless device is part of a second SD-WAN. While both devices reside in the same physical location (i.e., the same branch site 500), they may be in different virtual networks based on the identity of the user using that device.

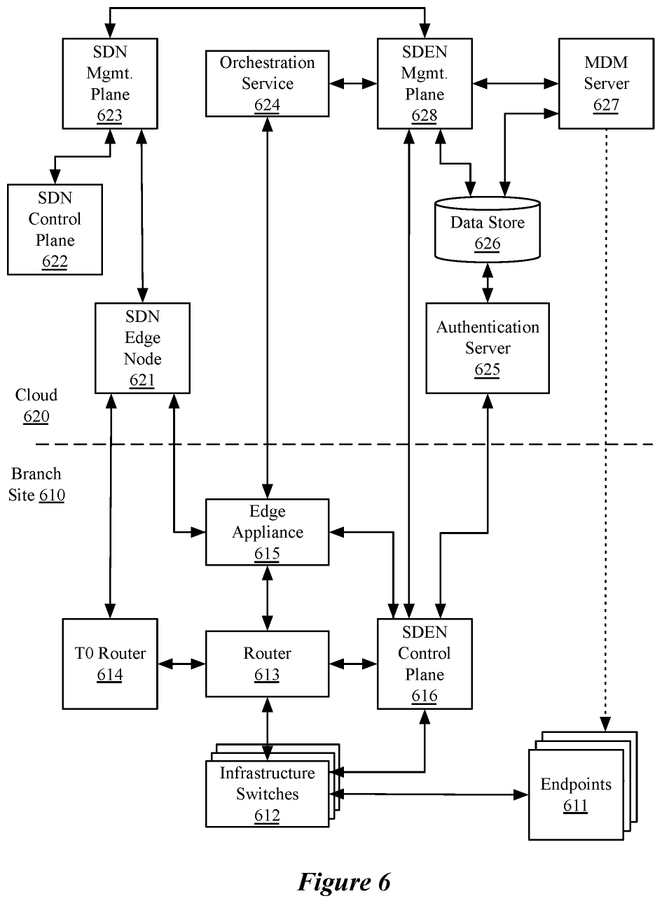

FIG. 6 illustrates a logical topology for implementing a branch site in some embodiments. In this example, a branch site 610 includes a set of one or more endpoints 611, a set of one or more infrastructure switches 612, a router 613, a TO router 614, an edge appliance 615, and an SDEN control plane 616. A cloud 620 includes an SDN edge node 621, an SDN control plane 622, an SDN management plane 623, an orchestration service 624, an authentication server 625, a data store 626, an MDM server 627, and an SDEN management plane 628.

In the branch site 610, the endpoints 611 include one or more of wireless devices and wired devices used by users in the branch site 610 (e.g., employees of the corporation at the branch site location). The endpoints 611 connect to the infrastructure switches 612. The infrastructure switches 612 are in some embodiments a set of managed switches configured by SDN servers (e.g., SDN managers and controllers) (not shown) operating at the branch site 610. The infrastructure switches 612 include in some embodiments, an MWN switch (e.g., through a secure WAP), a rack switch, an access switch (i.e., a managed wired network switch), and/or a core switch (such as the switches 530, 540, 550, and 560 in FIG. 5). In some embodiments, the endpoints 611 are placed in an SD-WAN based on the endpoint's MAC address and/or the user's group identity (e.g., the user's responsibility and role within the corporation). User group identities are maintained by the MDM server 627 in the cloud.

The infrastructure switches 612 communicate with the SDEN control plane 616, which includes a cluster of one or more SDEN controllers for dynamically associating the endpoints 611 with different SD-WANs implemented for different user groups. For instance, an MWN switch of the infrastructure switches 612 in some embodiments requests the SDEN control plane 616 to retrieve MDM attributes (e.g., SD-WAN tenant IDs) from the MDM server 627 in the cloud 620. The SDEN control plane 616 provides the MDM attributes to the MWN switch for the MWN switch to embed them (e.g., encapsulate) them onto data message flows sent by wireless devices of the endpoints 611. As another example, an access switch (e.g., a managed wired network switch) of the infrastructure switches 612 in some embodiments requests the SDEN control plane 616 to retrieve MDM attributes (e.g., SD-WAN tenant IDs) from the MDM server 627 in the cloud 620. The SDEN control plane 616 provides the MDM attributes to the access switch for the access switch to embed them (e.g., encapsulate) them onto data message flows sent by wired devices of the endpoints 611.

In some embodiments, the SDEN control plane 616 allows for communications between the MDM server 627 and the SDN components 621-623. The SDEN control plane 616 communicates with the authentication server 625 in the cloud 620 to authenticate a user of one or more endpoints 611. The SDEN control plane 616 and authentication server 625 in some embodiments operate similarly to the SDEN servers 175 and authentication server 180 of FIG. 1, respectively.

The authentication server 625 uses user identity information stored in the data store 626 to authenticate a user. In some embodiments, the data store 626 is a directory server (e.g., an Active Directory (AD) offered by Microsoft® Corporation) that stores directory service information, such as user and device information. The data store 626 is in some embodiments a centralized and hierarchical database. The authentication server 625 of some embodiments uses a protocol (e.g., Lightweight Directory Access Protocol (LDAP)) to access the data store 626.

The SDEN control plane 616 is managed by the SDEN management plane 628 residing in the cloud 620. In some embodiments, the SDEN management plane 628 includes a cluster of one or more management servers that manage the SDEN control plane 616 based on configuration data received from a network administrator. In some embodiments, the SDEN management plane 628 also manages the data store 626 and the MDM server 627. In the cloud 620, the SDN management plane 623 manages the SDN control plane 622 and the SDN edge node 621.

The infrastructure switches 612 also communicate with the router 613 in some embodiments. For instance, a core switch of the infrastructure switches 612 in some embodiments communicates directly with the router 613 for an MWN switch, rack switch, and access switch to communicate with the router 613. The router 613 connects to the edge appliance 615 to connect to the orchestration service 624. This connection provides a way for implementing multiple SD-WANs using the SDEN control plane 616 in the branch site 610 and the SDEN management plane 628 in the cloud 620. Further information regarding this connection will be described below. The edge appliance 615 is in some embodiments one part of an edge node (e.g., edge nodes 330-334) along with CE routers and/or broadband routers that use routing records to forward data messages to the cloud 520.

In some embodiments, the edge appliance 615 also connects to the SDN edge node 621 using a secure connection (e.g., a tunnel). While the edge appliance 615 is shown in this figure as connecting to components in a cloud site 620, in other embodiments, the edge appliance 615 connects to other edge nodes (e.g., edge appliances, TO routers, etc.) in other branch sites, hub nodes in datacenter sites, and cloud gateways in other cloud sites.

In some embodiments, the router 613 connects to a TO router 614 for implementing multiple logical networks. For instance, once the SDEN control plane 616 uses the MDM server 627 to identify which group to associate a particular endpoint 611. Using this information, the SDEN control plane 616 notifies the SDEN management plane 628 that the particular endpoint 611 needs logical network access to the cloud 620, so the SDEN management plane 628 relays this to the SDN management plane 623.

The SDN management plane 623 uses the SDN control plane 622 and the SDN edge node 621 to create a logical network connection (e.g., a secure channel, a tunnel (such as a Geneve tunnel)) between the SDN edge node 621 and the TO router 614 at the branch site 610. In such embodiments, the branch site 610 communicates with the cloud 620 using this connection instead of communicating between the edge appliance 615 and the orchestration service 624. Although the TO router 614 is illustrated here as communicating via a tunnel with an SDN edge node 621 in a cloud site 620, the TO router 614 in other embodiments connect to other TO routers or edge nodes in other branch sites, to bun nodes in datacenter sites, and to cloud gateways in cloud sites. These connections are in some embodiments established using tunnels (like the connection between the TO router 614 and the SDN edge node 621) between the TO router 614 and the other edge nodes, hub nodes, and cloud gateways in the other sites.

In some embodiments, the SDEN management plane 628 and the SDN management plane 623 are implemented as a single management plane in the cloud 620. Further information regarding this connection will be described below.

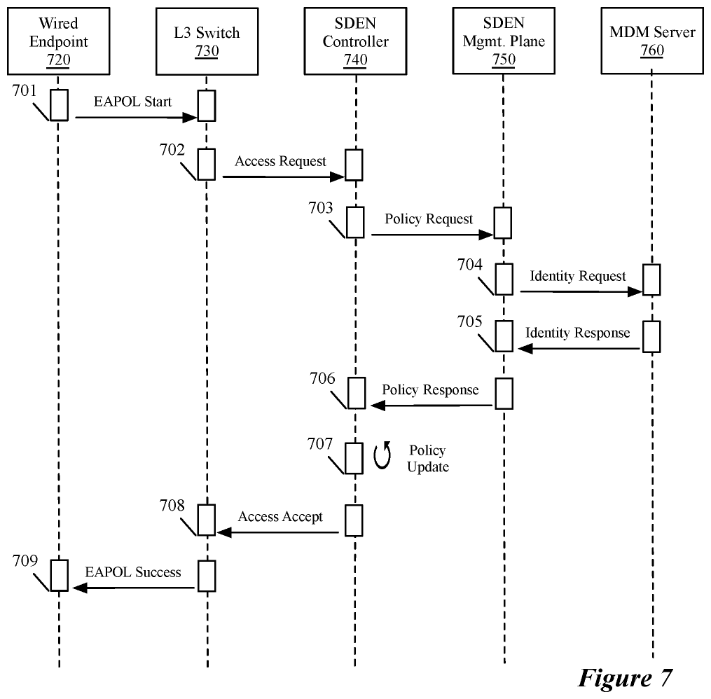

As described above, endpoints 611 of a branch site 610 can connect to an entity's shared network fabric using components residing in a cloud 620. In some embodiments, wired endpoints and wireless endpoints connect differently. Both scenarios will be further described below using specific examples. One of ordinary skill would understand that the flow of components described below is only an example way for the components to interact. Other permutations may be performed. FIG. 7 illustrates the communication between a wired endpoint 720, a layer 3 (L3) switch 730, an SDEN controller cluster 740, an SDEN management plane 750, and an MDM server set 760 for connecting the wired endpoint 720 residing in a branch site to a shared network fabric.

At 701, the wired endpoint 720 sends an Extensible Authentication Protocol (EAPOL) start request to the L3 switch 730. In some embodiments, the L3 switch 730 is a core switch of the branch site that the endpoint 720 accesses through an access switch (e.g., a managed wired network switch). The EAPOL start request is sent by the wired endpoint 720 when it wants to request access to the shared network fabric but does not know the MAC address of the authenticator (i.e., the SDEN controller cluster 740 in this example). After receiving the EAPOL start request, at 702, the L3 switch 730 provides an access request for the endpoint 720 to the SDEN controller cluster 740. In some embodiments, the SDEN controller cluster 740 is a set of one or more controllers operating as the SDEN control plane at the same branch site as the wired endpoint 720. The access request in some embodiments includes a set of attributes related to the wired endpoint 720 and/or the user using the endpoint. For instance, the set of attributes can include a MAC address of the endpoint 720 and a set of credentials (e.g., a username and password) for the user.

After receiving the access request, at 703, the SDEN controller cluster 740 sends a network policy request to the SDEN management plane 750. The SDEN management plane 750 of some embodiments resides in a cloud of the shared network fabric (such as the SDEN management plane 628 of FIG. 6). The policy request in some embodiments requests a policy related to the virtual network to which the wired endpoint 720 belongs. In some embodiments, the SDEN controller cluster 740 includes the MAC address of the wired endpoint 720 in the policy request.

At 704, the SDEN management plane 750 sends an identity request to the MDM server set 760. The MDM server set 760 resides in the cloud along with the SDEN management plane 750. In some embodiments, the identity request includes the MAC address of the wired endpoint 720 for the MDM server set 760 to determine which group the endpoint belongs. In other embodiments, the identity request includes the user's credentials for the MDM server set 760 to determine which group the user belongs. Still, in other embodiments, the identity request includes both the endpoint's MAC address and the user's credentials for the MDM server set 760 to determine which group the user and the endpoint belong.

At 705, the MDM server set 760 provides an identity response to the SDEN management plane 750. In some embodiments, the identity response includes a group ID specifying the user and/or endpoint's group. After receiving the identity response, at 706, the SDEN management plane 750 uses the group ID to determine the network policy for the wired endpoint 720, and provides the network policy to the SDEN controller 740.

Using the received network policy, at 707, the SDEN controller cluster 740 updates the network policy. For example, the SDEN controller cluster 740 of some embodiments, updates a mapping between the endpoint's MAC address and an SD-WAN tenant ID associated with the received group ID. The SDEN controller cluster 740 of some embodiments also updates an access control list (ACL) and/or a Quality-of-Service (QOS) associated with the network policy.

At 708, the SDEN controller cluster 740 sends an access accept message to the L3 switch 730 to notify that the endpoint's access request has been accepted. In some embodiments, the SDEN controller cluster 740 also provides an ACL and/or QoS update to the L3 switch 730. Lastly, at 709, the L3 switch 730 sends an EAPOL success message to the wired endpoint 720. After this message has been sent, the wired endpoint 720 is able to connect to the shared network fabric using the correct virtual network with which it is associated.

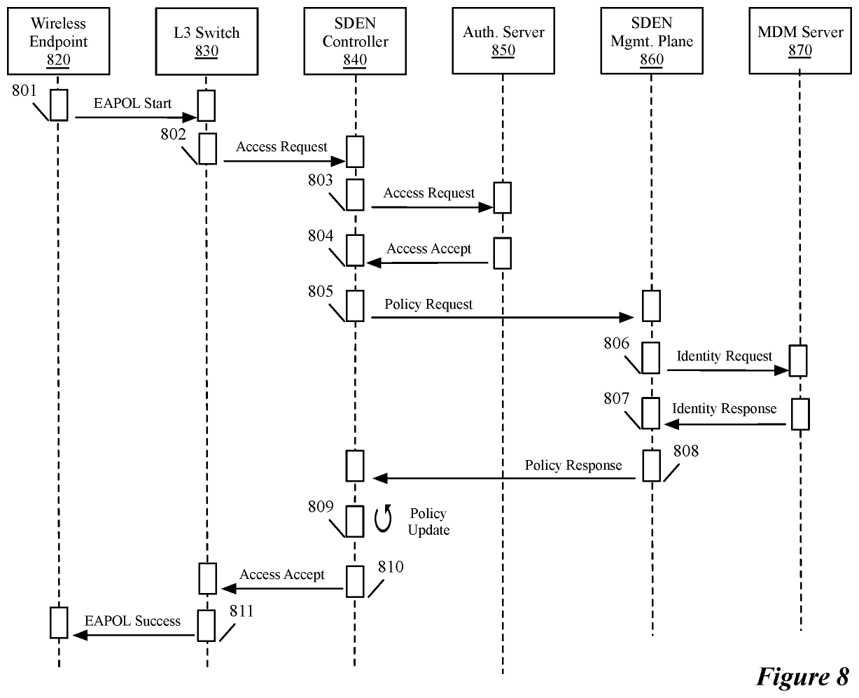

In some embodiments, wireless endpoints connect to the shared network fabric differently than wired endpoints. FIG. 8 illustrates the communication between a wireless endpoint 820, an L3 switch 830, an SDEN controller cluster 840, an authentication server 850, an SDEN management plane 860, and an MDM server set 870 for connecting the wireless endpoint 820 residing in a branch site to a shared network fabric.

At 801, the wireless endpoint 820 sends an EAPOL start request to the L3 switch 830. In some embodiments, the L3 switch 830 is a core switch of the branch site that the endpoint 820 accesses through a WAP and a managed wireless network switch. The EAPOL start request is sent by the wireless endpoint 820 when it wants to request access to the shared network fabric but does not know the MAC address of the authenticator (i.e., the authentication server 850 in this example). After receiving the EAPOL start request, at 802, the L3 switch 830 provides an access request for the endpoint 820 to the SDEN controller cluster 840. In some embodiments, the SDEN controller cluster 840 is a set of one or more controllers operating as the SDEN control plane at the same branch site as the wireless endpoint 820. The access request in some embodiments includes a set of attributes related to the wireless endpoint 820 and/or the user using the endpoint. For instance, the set of attributes can include a MAC address of the endpoint 820 and a set of credentials (e.g., a username and password) for the user.

At 803, the SDEN controller cluster 840 sends an access request to the authentication server 850. In some embodiments, the authentication server 850 resides in a cloud site of the shared network fabric (such as the authentication server 625 of FIG. 6). In other embodiments, it resides in the same branch site as the wireless endpoint 820 and the SDEN controller cluster 840. The access request of some embodiments includes the user's set of credentials for the authentication server 850 to authenticate. In other embodiments, it also includes the endpoint's MAC address because the authentication server 850 has to authenticate not only the user but the endpoint 820 used by the user as well. Once the authentication server 850 has authenticated the user/endpoint, at 804, it sends an access accept message to the SDEN controller cluster 840.

After receiving the access accept message, at 805, the SDEN controller cluster 840 sends a network policy request to the SDEN management plane 860. The SDEN management plane 860 of some embodiments resides in a cloud along with the authentication server 850 (such as the SDEN management plane 628 of FIG. 6). The policy request in some embodiments requests a policy related to the virtual network to which the wireless endpoint 820 belongs. In some embodiments, the SDEN controller cluster 840 includes the MAC address of the wireless endpoint 820 in the policy request.

At 806, the SDEN management plane 860 sends an identity request to the MDM server set 870. The MDM server set 870 resides in the cloud along with the SDEN management plane 860 and the authentication server 850. In some embodiments, the identity request includes the MAC address of the wireless endpoint 820 for the MDM server set 870 to determine which group the endpoint belongs. In other embodiments, the identity request includes the user's credentials for the MDM server set 870 to determine which group the user belongs. Still, in other embodiments, the identity request includes both the endpoint's MAC address and the user's credentials for the MDM server set 870 to determine which group the user and the endpoint belong.

At 807, the MDM server set 870 provides an identity response to the SDEN management plane 860. In some embodiments, the identity response includes a group ID specifying the user and/or endpoint's group. After receiving the identity response, at 808, the SDEN management plane 860 uses the group ID to determine the network policy for the wireless endpoint 820, and provides the network policy to the SDEN controller cluster 840.

Using the received network policy, at 809, the SDEN controller cluster 840 updates the network policy. For example, the SDEN controller cluster 840 of some embodiments, updates a mapping between the endpoint's MAC address and an SD-WAN tenant ID associated with the received group ID. The SDEN controller cluster 840 of some embodiments also updates an ACL and/or a QoS associated with the network policy.

At 810, the SDEN controller cluster 840 sends an access accept message to the L3 switch 830 to notify that the endpoint's access request has been accepted. In some embodiments, the SDEN controller cluster 840 also provides an ACL and/or QoS update to the L3 switch 830. Lastly, at 811, the L3 switch 830 sends an EAPOL success message to the wireless endpoint 820. After this message has been sent, the wireless endpoint 820 is able to connect to the shared network fabric using the correct virtual network with which it is associated.

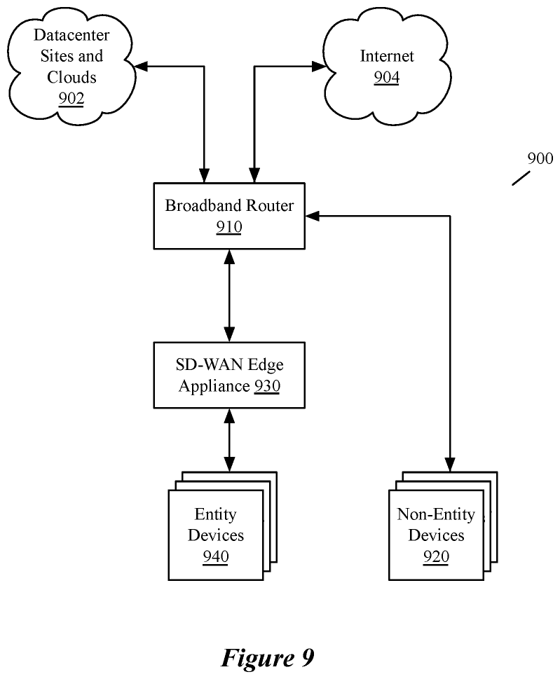

In some embodiments, a simpler branch site or a home office of the shared network fabric does not include many of the same components as a larger branch site (such as the branch site 500 of FIG. 5). FIG. 9 illustrates a physical topology of an example remote site 900. In some embodiments, the remote site 900 is a branch site of an entity. In other embodiments, it is a home office used by one or more users of the entity.

In this example, the remote site 900 communicates with one or more datacenter sites and one or more cloud sites 902 through a broadband router 910. In some embodiments, the broadband router 910 is a standalone physical router or customer premises equipment (CPE) to connect to other resources in other sites or the Internet 904. In other embodiments, it is a software router executing on a host computer in the remote site 900. The remote site 900 also communicates with the Internet 904. In some embodiments, one or more cloud sites 902 include one or more MDM servers (not shown) for use by the remote site 900.

The broadband router 910 of some embodiments connects directly to non-entity devices 920 residing in the remote site 900. Non-entity devices 920 in some embodiments include wired and/or wireless personal devices of the user (i.e., not authorized for use of the datacenter sites and clouds 902 by the user) or devices of non-users at the remote site 900 (e.g., guests or family members of the user). The broadband router 910 connects to an SD-WAN edge appliance 930 in the remote site 900. In some embodiments, the SD-WAN edge appliance 930 operates as a standalone computer. In other embodiments, it runs as a software edge node on a host computer in the remote site 900.

In some embodiments, the SD-WAN edge appliance 930 includes a router that performs the data message forwarding operations of the SD-WAN edge appliance. In such embodiments, the next-hop forwarding records of the SD-WAN edge appliance 930 are routing records used by the router to forward data messages to the datacenter sites and clouds 902.

In some embodiments, the SD-WAN edge appliance 930 includes two or more edge devices, with each edge device connected to the datacenter sites and clouds 902 through different communication service providers (e.g., an MPLS device, a cable modem router, a 5G router, etc.). In some of these embodiments, the edge devices of the SD-WAN edge appliance 930 connect to each other using a physical cable link.

The SD-WAN edge appliance 930 connects to entity devices 940 residing in the remote site 900. Entity devices 940 in some embodiments include wired and/or wireless devices that are authorized to access the datacenter sites and cloud sites 902 of the entity. For example, work-designated devices of an employee of a corporation are entity devices.

The entity devices 940 are in some embodiments part of one or more SD-WANs established for the remote office's entity. For instance, a first entity device is in some embodiments part of a first SD-WAN, while a second entity device is part of a second SD-WAN. While both devices reside in the same physical location (i.e., the same remote site 900), they may be in different virtual networks based on the identity of the user using that device. In some embodiments, non-entity devices 920 are also part of one or more SD-WANs established for the remote office's entity. For example, the entity of some embodiments includes one or more SD-WANs for devices not belonging to the entity in order to isolate entity traffic from non-entity traffic.

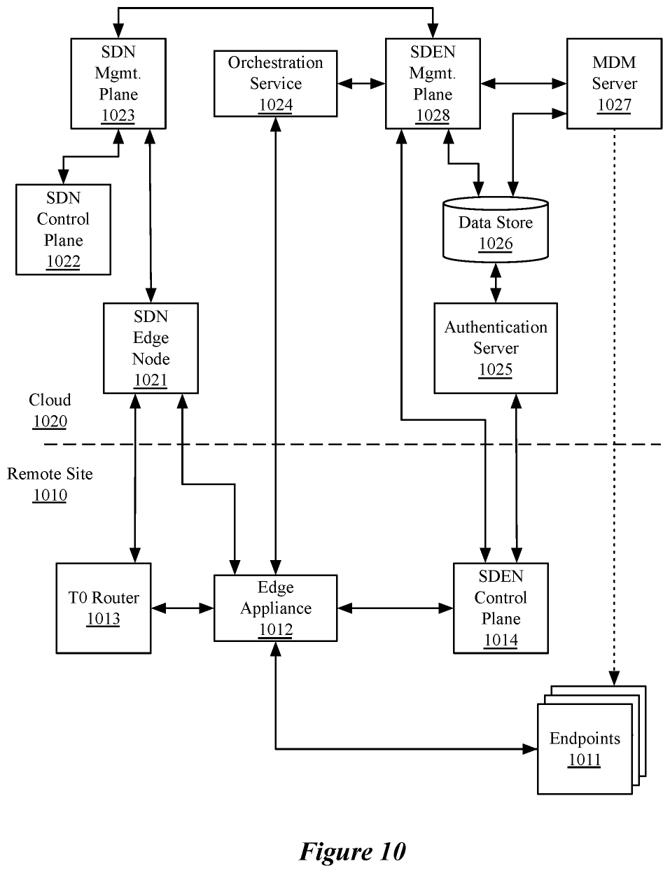

FIG. 10 illustrates a logical topology for implementing a remote site in some embodiments. In this example, a remote site 1010 includes a set of one or more endpoints 1011, an SD-WAN edge appliance 1012, a TO router 1013, and an SDEN control plane 1014. A cloud 1020 includes an SDN edge node 1021, an SDN control plane 1022, an SDN management plane 1023, an orchestration service 1024, an authentication server 1025, a data store 1026, an MDM server 1027, and an SDEN management plane 1028.

In the remote site 1010, the endpoints 1011 include one or more of wired devices and wireless devices used by users in the remote site 1010. The endpoints 1011 connect to the edge appliance 1012. In some embodiments, the endpoints 1011 are placed in an SD-WAN based on the endpoint's MAC address and/or the user's group identity (e.g., the user's responsibility and role within the corporation). User group identities are maintained by the MDM server 1027 in the cloud 1020.

The edge appliance 1012 communicates with the SDEN control plane 1014, which includes a cluster of one or more SDEN controllers for dynamically associating the endpoints 1011 with different SD-WANs implemented for different user groups. In some embodiments, the SDEN control plane 1014 allows for communications between the MDM server 1027 and the SDN components 1021-1023. The SDEN control plane 1014 communicates with the authentication server 1025 in the cloud 1020 to authenticate a user of one or more endpoints 1011. The SDEN control plane 1014 and authentication server 1025 in some embodiments operate similarly to the SDEN servers 175 and authentication server 180 of FIG. 1, respectively.

The authentication server 1025 uses user identity information stored in the data store 1026 to authenticate a user. In some embodiments, the data store 1026 is a directory server (e.g., an AD offered by Microsoft® Corporation) that stores directory service information, such as user and device information. The data store 1026 is in some embodiments a centralized and hierarchical database. The authentication server 1025 of some embodiments uses a protocol (e.g., (LDAP) to access the data store 1026.

The SDEN control plane 1014 is managed by the SDEN management plane 1028 residing in the cloud 1020. In some embodiments, the SDEN management plane 1028 includes a cluster of one or more management servers that manage the SDEN control plane 1014 based on configuration data received from a network administrator. In some embodiments, the SDEN management plane 1028 also manages the data store 1026 and the MDM server 1027. In the cloud 1020, the SDN management plane 1023 manages the SDN control plane 1022 and the SDN edge node 1021.

The edge appliance 1012 also connects to the orchestration service 1024. This connection provides a way for implementing multiple SD-WANs using the SDEN control plane 1014 in the remote site 1010 and the SDEN management plane 1028 in the cloud 1020. Further information regarding this connection will be described below.

In some embodiments, the edge appliance 1012 includes a router that performs the data message forwarding operations of the edge appliance. In such embodiments, the next-hop forwarding records of the edge appliance 1012 are routing records used by the router to forward data messages to the cloud 1020.

In some embodiments, the edge appliance 1012 includes two or more edge devices, with each edge device connected to the cloud 1020 through different communication service providers (e.g., an MPLS device, a cable modem router, a 5G router, etc.). In some of these embodiments, the edge devices of the edge appliance 1012 connect to each other using a physical cable link.

In some embodiments, the edge appliance 1012 connects to a TO router 1013 for implementing multiple logical networks. For instance, once the SDEN control plane 1014 uses the MDM server 1027 to identify which group to associate a particular endpoint 1011. Using this information, the SDEN control plane 1014 notifies the SDEN management plane 1028 that the particular endpoint 1011 needs logical network access to the cloud 1020, so the SDEN management plane 1028 relays this to the SDN management plane 1023.

The SDN management plane 1023 uses the SDN control plane 1022 and the SDN edge node 1021 to create a logical network connection (e.g., a secure channel, a tunnel (such as a Geneve tunnel)) between the SDN edge node 1021 and the TO router 1013 at the remote site 1010. In such embodiments, the remote site 1010 communicates with the cloud using this connection instead of communicating between the edge appliance 1012 and the orchestration service 1024. In some of these embodiments, the SDEN management plane 1028 and the SDN management plane 1023 are implemented as a single management plane in the cloud 1020. Further information regarding this connection will be described below.

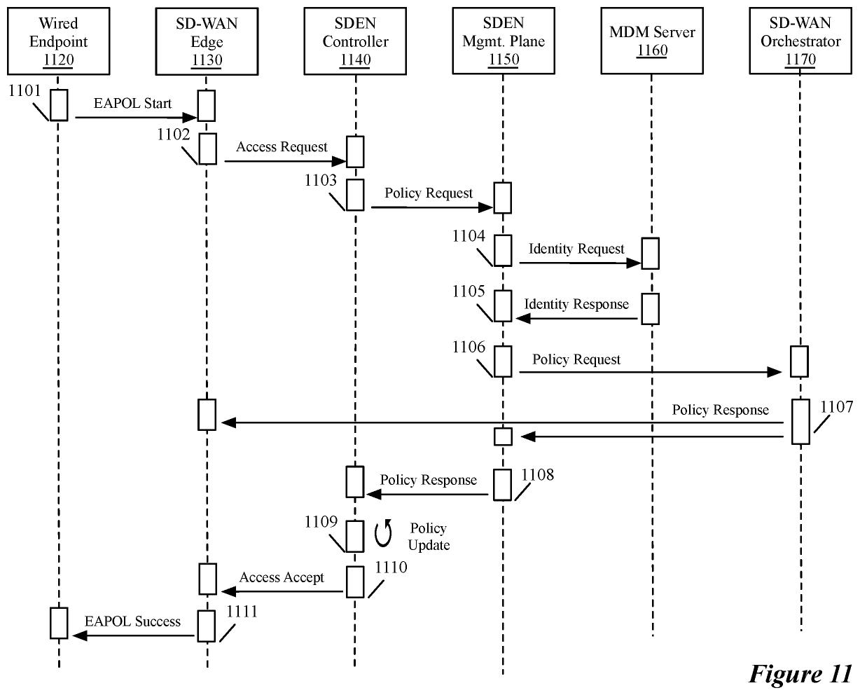

As described above, endpoints 1011 of a remote site 1010 can connect to an entity's shared network fabric using components residing in a cloud 1020. In some embodiments, wired endpoints and wireless endpoints of a remote site connect differently. Both scenarios will be further described below using specific examples. One of ordinary skill would understand that the flow of components described below is only an example way for the components to interact. Other permutations may be performed. FIG. 11 illustrates the communication between a wired endpoint 1120, an SD-WAN edge appliance 1130, an SDEN controller cluster 1140, an SDEN management plane 1150, an MDM server set 1160, and an SD-WAN orchestrator 1170 for connecting the wired endpoint 1120 residing in a remote site (e.g., a home office) to a shared network fabric.

At 1101, the wired endpoint 1120 sends an EAPOL start request to the SD-WAN edge appliance 1130. The EAPOL start request is sent by the wired endpoint 1120 when it wants to request access to the shared network fabric but does not know the MAC address of the authenticator (i.e., the SDEN controller cluster 1140 in this example). After receiving the EAPOL start request, at 1102, the SD-WAN edge appliance 1130 provides an access request for the endpoint 1120 to the SDEN controller cluster 1140. In some embodiments, the SDEN controller cluster 1140 is a set of one or more controllers operating as the SDEN control plane at the same branch site as the wired endpoint 1120. The access request in some embodiments includes a set of attributes related to the wired endpoint 1120 and/or the user using the endpoint. For instance, the set of attributes can include a MAC address of the endpoint 1120 and a set of credentials (e.g., a username and password) for the user.

After receiving the access request, at 1103, the SDEN controller cluster 1140 sends a network policy request to the SDEN management plane 1150. The SDEN management plane 1150 of some embodiments resides in a cloud of the shared network fabric (such as the SDEN management plane 1028 of FIG. 10). The policy request in some embodiments requests a policy related to the virtual network to which the wired endpoint 1120 belongs. In some embodiments, the SDEN controller cluster 1140 includes the MAC address of the wired endpoint 1120 in the policy request.

At 1104, the SDEN management plane 1150 sends an identity request to the MDM server set 1160. The MDM server set 1160 resides in the cloud along with the SDEN management plane 1150. In some embodiments, the identity request includes the MAC address of the wired endpoint 1120 for the MDM server set 1160 to determine which group the endpoint belongs. In other embodiments, the identity request includes the user's credentials for the MDM server set 1160 to determine which group the user belongs. Still, in other embodiments, the identity request includes both the endpoint's MAC address and the user's credentials for the MDM server set 1160 to determine which group the user and the endpoint belong.

At 1105, the MDM server set 1160 provides an identity response to the SDEN management plane 1150. In some embodiments, the identity response includes a group ID specifying the user and/or endpoint's group. After receiving the identity response, at 1106, the SDEN management plane 1150 provides the policy request to the SD-WAN orchestrator 1170. The SD-WAN orchestrator 1170 of some embodiments resides in a cloud of the shared network fabric along with the SDEN management plane 1150. In some embodiments, the policy request sent at 1106 includes the group ID determined by the MDM server set 1160. At 1107, the SD-WAN orchestrator 1170 determines the network policy for the endpoint 1120 and provides a policy response to the SDEN management plane 1150 and the SD-WAN edge appliance 1130.

At 1108, the SDEN management plane 1150 provides the policy response to the SDEN controller cluster 1140. Using the received network policy, at 1109, the SDEN controller cluster 1140 updates the network policy. For example, the SDEN controller cluster 1140 of some embodiments, updates a mapping between the endpoint's MAC address and an SD-WAN tenant ID associated with the received group ID. The SDEN controller cluster 1140 of some embodiments also updates an ACL and/or a QoS associated with the network policy.

At 1110, the SDEN controller cluster 1140 sends an access accept message to the SD-WAN edge appliance 1130 to notify that the endpoint's access request has been accepted. In some embodiments, the SDEN controller cluster 1140 also provides an ACL and/or QoS update to the SD-WAN edge appliance 1130. Lastly, at 1111, the SD-WAN edge appliance 1130 sends an EAPOL success message to the wired endpoint 1120. After this message has been sent, the wired endpoint 1120 is able to connect to the shared network fabric using the correct virtual network with which it is associated.

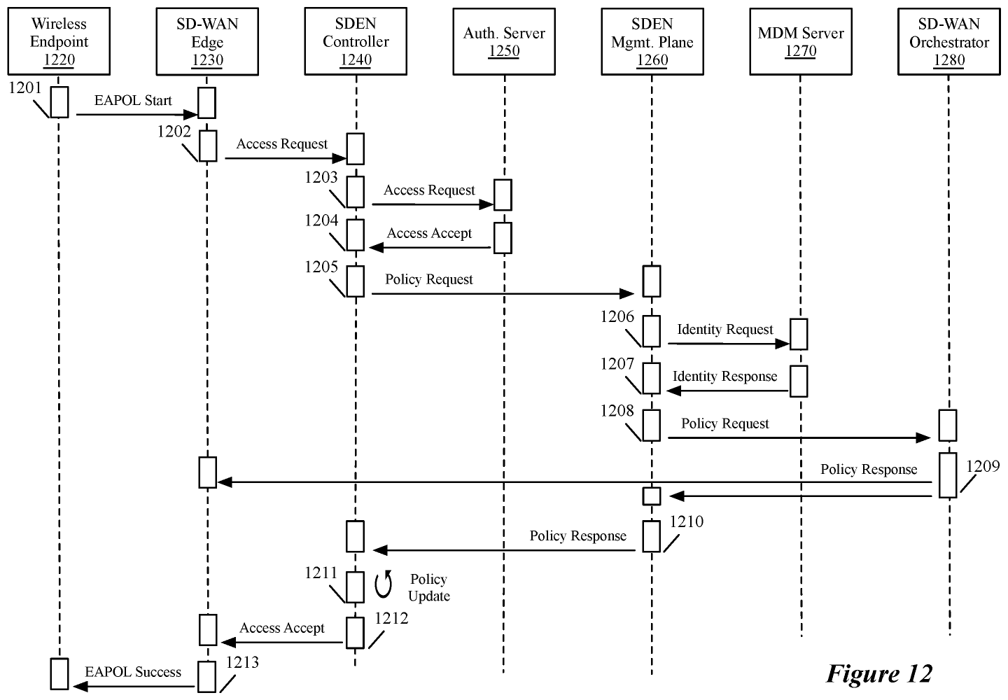

In some embodiments, wireless endpoints of a remote site connect to the shared network fabric differently than wired endpoints. FIG. 12 illustrates the communication between a wireless endpoint 1220, an SD-WAN edge appliance 1230, an SDEN controller cluster 1240, an authentication server 1250, an SDEN management plane 1260, an MDM server set 1270, and an SD-WAN orchestrator 1280 for connecting the wireless endpoint 1220 residing in a remote site to a shared network fabric.

At 1201, the wireless endpoint 1220 sends an EAPOL start request to the SD-WAN edge appliance 1230. The EAPOL start request is sent by the wireless endpoint 1220 when it wants to request access to the shared network fabric but does not know the MAC address of the authenticator (i.e., the authentication server 1250 in this example). After receiving the EAPOL start request, at 1202, the SD-WAN edge appliance 1230 provides an access request for the endpoint 1220 to the SDEN controller cluster 1240. In some embodiments, the SDEN controller cluster 1240 is a set of one or more controllers operating as the SDEN control plane at the same remote site as the wireless endpoint 1220. The access request in some embodiments includes a set of attributes related to the wireless endpoint 1220 and/or the user using the endpoint. For instance, the set of attributes can include a MAC address of the endpoint 1220 and a set of credentials (e.g., a username and password) for the user.

At 1203, the SDEN controller cluster 1240 sends an access request to the authentication server 1250. In some embodiments, the authentication server 1250 resides in a cloud site of the shared network fabric (such as the authentication server 1025 of FIG. 10). In other embodiments, it resides in the same remote site as the wireless endpoint 1220 and the SDEN controller cluster 1240. The access request of some embodiments includes the user's set of credentials for the authentication server 1250 to authenticate. In other embodiments, it also includes the endpoint's MAC address because the authentication server 1250 has to authenticate not only the user but the endpoint 1220 used by the user as well. Once the authentication server 1250 has authenticated the user/endpoint, at 1204, it sends an access accept message to the SDEN controller cluster 1240.

After receiving the access accept message, at 1205, the SDEN controller cluster 1240 sends a network policy request to the SDEN management plane 1260. The SDEN management plane 1260 of some embodiments resides in a cloud along with the authentication server 1250 (such as the SDEN management plane 1028 of FIG. 10). The policy request in some embodiments requests a policy related to the virtual network to which the wireless endpoint 1220 belongs. In some embodiments, the SDEN controller cluster 1240 includes the MAC address of the wireless endpoint 1220 in the policy request.

At 1206, the SDEN management plane 1260 sends an identity request to the MDM server set 1270. The MDM server set 1270 resides in the cloud along with the SDEN management plane 1260 and the authentication server 1250. In some embodiments, the identity request includes the MAC address of the wireless endpoint 1220 for the MDM server set 1270 to determine which group the endpoint belongs. In other embodiments, the identity request includes the user's credentials for the MDM server set 1270 to determine which group the user belongs. Still, in other embodiments, the identity request includes both the endpoint's MAC address and the user's credentials for the MDM server set 1270 to determine which group the user and the endpoint 1220 belong.

At 1207, the MDM server set 1270 provides an identity response to the SDEN management plane 1260. In some embodiments, the identity response includes a group ID specifying the user and/or endpoint's group. After receiving the identity response, at 1208, the SDEN management plane 1260 provides the policy request to the SD-WAN orchestrator 1280. The SD-WAN orchestrator 1280 of some embodiments resides in a cloud of the shared network fabric along with the SDEN management plane 1260. In some embodiments, the policy request sent at 1208 includes the group ID determined by the MDM server set 1270. At 1209, the SD-WAN orchestrator 1280 determines the network policy for the endpoint 1220 and provides a policy response to the SDEN management plane 1260 and the SD-WAN edge appliance 1230.

At 1210, the SDEN management plane 1260 provides the policy response to the SDEN controller cluster 1240. Using the received network policy, at 1211, the SDEN controller cluster 1240 updates the network policy. For example, the SDEN controller cluster 1240 of some embodiments, updates a mapping between the endpoint's MAC address and an SD-WAN tenant ID associated with the received group ID. The SDEN controller cluster 1240 of some embodiments also updates an ACL and/or a QoS associated with the network policy.

At 1212, the SDEN controller cluster 1240 sends an access accept message to the SD-WAN edge appliance 1230 to notify that the endpoint's access request has been accepted. In some embodiments, the SDEN controller cluster 1240 also provides an ACL and/or QoS update to the SD-WAN edge appliance 1230. Lastly, at 1213, the SD-WAN edge appliance 1230 sends an EAPOL success message to the wireless endpoint 1220. After this message has been sent, the wireless endpoint 1220 is able to connect to the shared network fabric using the correct virtual network with which it is associated.

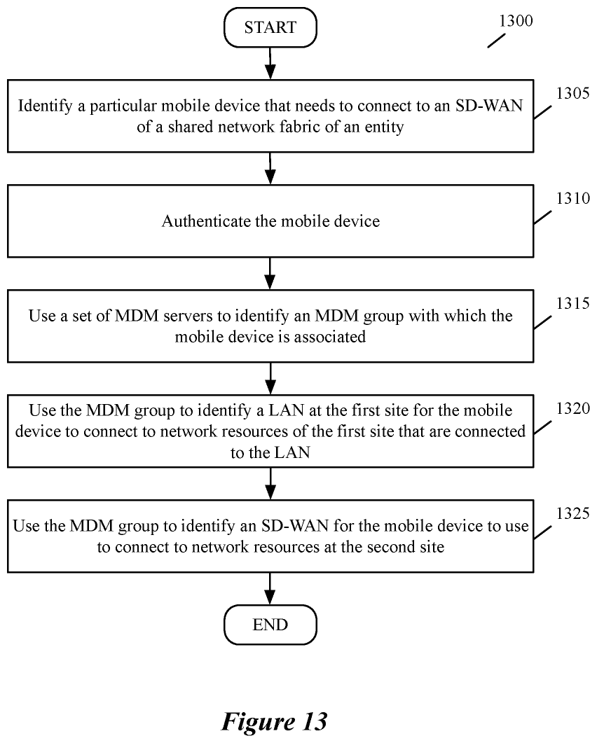

As discussed previously, a site (e.g., a branch site, a remote site, etc.) of some embodiments, that implements multiple SD-WANs, connects to a cloud site using an edge appliance and an orchestration service facilitated by an SDN management plane in the cloud and an SDN control plane at the site. FIG. 13 conceptually illustrates a process 1300 of some embodiments for dynamically associating mobile devices with different SD-WANs on a shared network fabric of an entity. This process 1300 is performed in some embodiments by a set of SDEN servers implementing an SDEN control plane at a first site of the entity connected to a second site of the entity through the SD-WANs. The process 1300 is performed in some embodiments when the second site includes an orchestration service (e.g., a VeloCloud® orchestration service) to connect to the first site.

In some embodiments, at least two different SD-WANs are implemented for at least two different groups of the entity. These groups are in some embodiments different user groups of the entity. These groups in other embodiments are different device groups of the entity. The groups in other embodiments are a combination of user and device groups of the entity. The process 1300 will be described in relation to the components of FIG. 6, however one of ordinary skill will realize that different configurations of branch sites and cloud sites may be used.

The process 1300 begins by identifying (at 1305) a particular mobile device that needs to connect to an SD-WAN of the shared network fabric. In some embodiments, the SDEN control plane 616 receives, through the set of infrastructure switches 612 (e.g., through an MWN switch), a request from the particular mobile device (i.e., an endpoint 611) to connect to the entity's shared network fabric. This request includes at least one of a MAC address of the mobile device and a set of user credentials (e.g., a username and password) for the user of the mobile device.

Next, the process 1300 authenticates (at 1310) the particular mobile device. In some embodiments, the SDEN control plane 616 uses the authentication server 625 in the cloud 620 to authenticate the mobile device. In other embodiments, the SDEN control plane 616 uses a different authentication server operating in the branch site 610. The mobile device is authenticated in some embodiments based on its MAC address. For instance, the authentication server 625 can use the data store 626 to retrieve a policy associated with the MAC address to determine whether the device itself is allowed to access the shared network fabric.

In other embodiments, the authentication server 625 uses the user's authentication credentials to determine (e.g., based on a policy stored in the data store 626) whether the user is allowed to access the shared network fabric. Still, in other embodiments, the authentication server 625 uses both the MAC address and the user's authentication credentials to authenticate the mobile device. In some embodiments, authentication of the mobile device is not necessary, and the step 1310 is not performed.

At 1315, the process 1300 uses a set of one or more MDM servers to identify an MDM group with which the particular mobile device is associated. Using the MDM server set 627, the SDEN control plane 616 of some embodiments determines to which device group the mobile device belongs. In such embodiments, the SDEN control plane 616 provides the device's MAC address to the MDM server set 627 to determine the device group. A device group is in some embodiments defined based on the device type, such as a first group for laptops, a second group for smartphones, a third group for tablets, etc.

In other embodiments, the SDEN control plane 616 determines to which user group the user of the mobile device belongs. In such embodiments, the SDEN control plane 616 provides the user's credentials to the MDM server set 627 to determine the user group. The SDEN control plane 616 also provides the device's MAC address along with the user's credentials to identify the user group. In some embodiments, a user group is a group of members of the entity that share a set of characteristics. The set of characteristics in some embodiments include at least one of a shared responsibility for the entity, a shared role within the entity, and a shared subgroup of the entity.

After identifying the MDM group, the process 1300 uses (at 1320) the identified MDM group to identify a particular LAN at the first site for the particular mobile device to connect to network resources of the first site that are connected to the particular LAN. In some embodiments, the particular LAN includes the infrastructure switch set 612, the router 613, and the edge appliance 615 of the branch site 610. Using these components, the mobile device is able to connect to network resources within the branch site 610. In some embodiments, the network resources include one or more of servers (e.g., VMs, containers, Pods, etc.), applications, middlebox services (e.g., firewall services, network address translation services, load balancing services, etc.), and forwarding elements (e.g., routers, switches, etc.).

Lastly, the process 1300 uses (at 1325) the identified MDM group to identify a particular SD-WAN for the particular mobile device to use to connect to the second site to have access to a set of one or more network resources at the second site. In some embodiments, the SDEN control plane 616 uses the SDEN management plane 628 to connect the edge appliance 615 in the branch site 610 to the orchestration server 624 in the cloud 620 in order to connect the two sites. In such embodiments, the SDEN control plane 616 notifies the SDEN management plane 628 that the mobile device needs an SD-WAN connection to connect to the cloud 620, and the SDEN management plane 628 directs the orchestration service 624 to connect to the edge appliance 615. The particular LAN is in some embodiments a first logical network of several logical networks implemented at the branch site for several different groups of mobile devices. These logical networks are implemented in some embodiments to isolate data message flows between the different groups. After identifying the particular SD-WAN to connect the particular mobile device to the second site, the process 1300 ends.

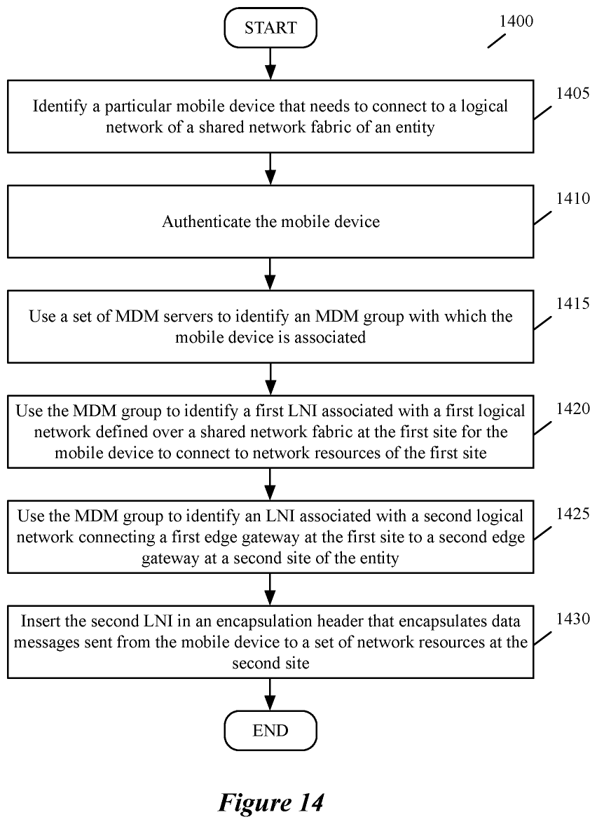

In some embodiments, a first site (e.g., a branch site, a remote site, etc.), that implements multiple logical networks, connects to a second site using a connection between a TO router and an SDN edge node facilitated by an SDN management plane in the second site and an SDN control plane at the first site. FIG. 14 conceptually illustrates a process 1400 of some embodiments for dynamically associating mobile devices with different logical networks implemented on a shared network fabric of an entity. This process 1400 is performed in some embodiments by a set of SDEN servers implementing an SDEN control plane at a first site of the entity connected to a second site of the entity through the logical networks. In some embodiments, the first site is a branch site and the second site is a cloud site. In other embodiments, the first and second sites are both branch sites. Still, in other embodiments, the first site is a branch site and the second site is a datacenter site.

In some embodiments, at least two different logical networks are implemented for at least two different groups of the entity. These groups are in some embodiments different user groups of the entity. These groups in other embodiments are different device groups of the entity. The groups in other embodiments are a combination of user and device groups of the entity. The process 1400 will be described in relation to the components of FIG. 6, however one of ordinary skill will realize that different configurations of branch sites and cloud sites may be used.

The process 1400 begins by identifying (at 1405) a particular mobile device that needs to connect to a logical network of the shared network fabric of an entity. In some embodiments, the SDEN control plane 616 receives, through the set of infrastructure switches 612 (e.g., through an MWN switch), a request from the particular mobile device (i.e., an endpoint 611) to connect to the entity's shared network fabric. This request includes at least one of a MAC address of the mobile device and a set of user credentials (e.g., a username and password) for the user of the mobile device.

Next, the process 1400 authenticates (at 1410) the particular mobile device. In some embodiments, the SDEN control plane 616 uses the authentication server 625 in the cloud 620 to authenticate the mobile device. In other embodiments, the SDEN control plane 616 uses a different authentication server operating in the branch site 610. The mobile device is authenticated in some embodiments based on its MAC address. For instance, the authentication server 625 can use the data store 626 to retrieve a policy associated with the MAC address to determine whether the device itself is allowed to access the shared network fabric.

In other embodiments, the authentication server 625 uses the user's authentication credentials to determine (e.g., based on a policy stored in the data store 626) whether the user is allowed to access the shared network fabric. Still, in other embodiments, the authentication server 625 uses both the MAC address and the user's authentication credentials to authenticate the mobile device. In some embodiments, authentication of the mobile device is not necessary, and the step 1410 is not performed.

At 1415, the process 1400 uses a set of one or more MDM servers to identify an MDM group with which the particular mobile device is associated. Using the MDM server set 627, the SDEN control plane 616 of some embodiments determines to which device group the mobile device belongs. In such embodiments, the SDEN control plane 616 provides the device's MAC address to the MDM server set 627 to determine the device group. A device group is in some embodiments defined based on the device type, such as a first group for laptops, a second group for smartphones, a third group for tablets, etc.

In other embodiments, the SDEN control plane 616 determines to which user group the user of the mobile device belongs. In such embodiments, the SDEN control plane 616 provides the user's credentials to the MDM server set 627 to determine the user group. The SDEN control plane 616 also provides the device's MAC address along with the user's credentials to identify the user group. In some embodiments, a user group is a group of members of the entity that share a set of characteristics. The set of characteristics in some embodiments include at least one of a shared responsibility for the entity, a shared role within the entity, and a shared subgroup of the entity.

After identifying the MDM group, the process 1400 uses (at 1420) the identified MDM group to identify a first LNI associated with a first logical network that is defined over a shared network fabric at the first site for the particular mobile device to connect to network resources of the first site that are connected to the first logical network. In some embodiments, in identifying the MDM group, the SDEN control plane 616 receives from the MDM server set 627 an MDM group ID for the MDM group. In such embodiments, the SDEN control plane 616 uses the MDM group ID to identify the first LNI for the first logical network associated with that group.

In some embodiments, the identified first logical network includes the infrastructure switch set 612, router 613, and TO router 614. Using these components, the mobile device is able to connect to network resources (e.g., using a secure connection or a tunnel) within the branch site 610. In some embodiments, the network resources include one or more of servers (e.g., VMs, containers, Pods, etc.), applications, middlebox services (e.g., firewall services, network address translation services, load balancing services, etc.), and forwarding elements (e.g., routers, switches, etc.).

At 1425, the process 1400 uses the identified MDM group to identify a second LNI associated with a second logical network connecting a first edge gateway at the first site to a second edge gateway at a second site of the entity. The second logical network identified by the second LNI in some embodiments (1) spans the first and second sites and (2) connects the mobile device at the first site to the set of network resources at the second site. In some embodiments, the first LNI is the same as the second LNI, as the first and second logical networks are one network. In other embodiments, the first LNI is different than the second LNI, as the first and second logical networks are two different logical networks with the first logical network being a logical LAN and the second logical network being a logical WAN. The logical LAN spans only the first site (i.e., the branch site 610), while the logical WAN spans at least the first and second sites (i.e., the branch site 610 and the cloud site 620).

This step 105 is in some embodiments facilitated by the SDEN control plane 616 using the SDEN management plane 628 and the SDN management plane 623. For example, the SDEN control plane 616 of some embodiments notifies the SDEN management plane 628 of the second logical network needed to connect the branch site 610 to the cloud site 620. The SDEN management plane 628 notifies the SDN management plane 623 that the mobile device needs logical network access to the cloud 620.

The SDN management plane 623 uses the SDN control plane 622 and the SDN edge node 621 to create the second logical network between the SDN edge node 621 and the TO router 614 at the branch site 610. In some of these embodiments, the SDEN management plane 628 and the SDN management plane 623 are implemented as a single management plane in the cloud 620. In some embodiments, the second logical network connects the particular mobile device to a set of one or more network resources at the cloud site. Such network resources in some embodiments include servers, applications, middlebox services, and forwarding elements in the cloud 620. Because data message flows associated with the mobile device are routed between the TO router 614 and the SDN edge node 621, the mobile device can be seen as in the same overlay network as the network resources in the cloud 620.

Lastly, the process 1400 inserts (at 1430) the second LNI in an encapsulation header that encapsulates data messages sent from the particular mobile device to a set of one or more network resources at the second site. In some embodiments, the encapsulation header is a tunnel header used to send the data messages from the first edge gateway (i.e., the TO router 614) to the second edge gateway (i.e., the SDN edge node 621) through a tunnel established between the first and second edge gateways. This tunnel connects the first and second sites so that the mobile device is able to access the set of network resources at the second site. Because the data messages sent from the mobile device are sent using a secure connection (i.e., a tunnel), the mobile device can be seen as in the same overlay network as the set of network resources in the second site.

In some embodiments, the second LNI is inserted into the encapsulating header by the TO router 614 operating at the branch site 610 to forward the encapsulated data messages to the SDN edge node 621 at the cloud site 620. In some embodiments, this encapsulation header is a first tunnel header and the data messages sent to the second site are a first set of data messages. In such embodiments, the process 1400 also inserts the first LNI in a second encapsulation header that encapsulates a second set of data messages sent from the mobile device to the network resources of the first site. The second encapsulation header is also a tunnel header used to send the second set of data messages through a tunnel or a secure connection in some embodiments. After inserting the second LNI to send data messages from the mobile device to the network resources at the second site, the process 1400 ends.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

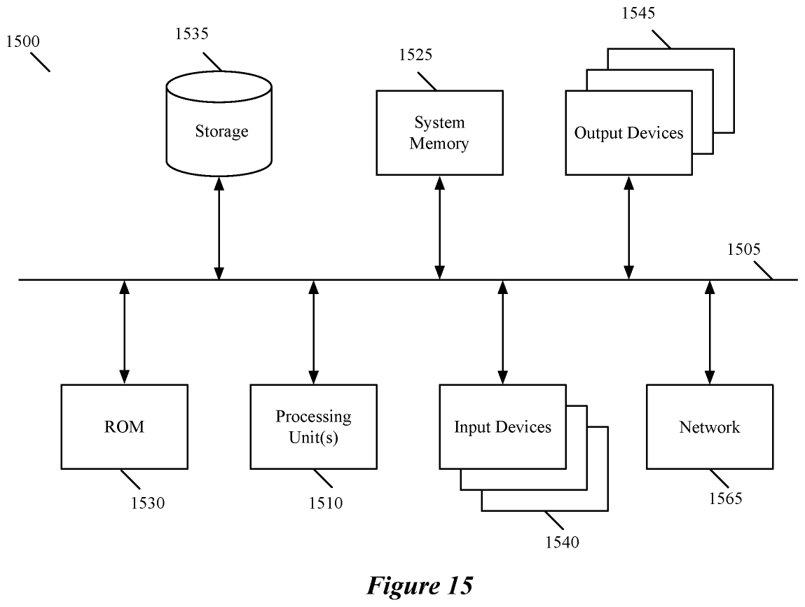

FIG. 15 conceptually illustrates a computer system 1500 with which some embodiments of the invention are implemented. The computer system 1500 can be used to implement any of the above-described computers and servers. As such, it can be used to execute any of the above described processes. This computer system includes various types of non-transitory machine readable media and interfaces for various other types of machine readable media. Computer system 1500 includes a bus 1505, processing unit(s) 1510, a system memory 1525, a read-only memory 1530, a permanent storage device 1535, input devices 1540, and output devices 1545.

The bus 1505 collectively represents all system, peripheral, and chipset buses that communicatively connect the numerous internal devices of the computer system 1500. For instance, the bus 1505 communicatively connects the processing unit(s) 1510 with the read-only memory 1530, the system memory 1525, and the permanent storage device 1535.

From these various memory units, the processing unit(s) 1510 retrieve instructions to execute and data to process in order to execute the processes of the invention. The processing unit(s) may be a single processor or a multi-core processor in different embodiments. The read-only-memory (ROM) 1530 stores static data and instructions that are needed by the processing unit(s) 1510 and other modules of the computer system. The permanent storage device 1535, on the other hand, is a read-and-write memory device. This device is a non-volatile memory unit that stores instructions and data even when the computer system 1500 is off. Some embodiments of the invention use a mass-storage device (such as a magnetic or optical disk and its corresponding disk drive) as the permanent storage device 1535.

Other embodiments use a removable storage device (such as a flash drive, etc.) as the permanent storage device. Like the permanent storage device 1535, the system memory 1525 is a read-and-write memory device. However, unlike storage device 1535, the system memory is a volatile read-and-write memory, such a random access memory. The system memory stores some of the instructions and data that the processor needs at runtime. In some embodiments, the invention's processes are stored in the system memory 1525, the permanent storage device 1535, and/or the read-only memory 1530. From these various memory units, the processing unit(s) 1510 retrieve instructions to execute and data to process in order to execute the processes of some embodiments.

The bus 1505 also connects to the input and output devices 1540 and 1545. The input devices enable the user to communicate information and select commands to the computer system. The input devices 1540 include alphanumeric keyboards and pointing devices (also called “cursor control devices”). The output devices 1545 display images generated by the computer system. The output devices include printers and display devices, such as cathode ray tubes (CRT) or liquid crystal displays (LCD). Some embodiments include devices such as a touchscreen that function as both input and output devices.

Finally, as shown in FIG. 15, bus 1505 also couples computer system 1500 to a network 1565 through a network adapter (not shown). In this manner, the computer can be a part of a network of computers (such as a local area network (“LAN”), a wide area network (“WAN”), or an Intranet, or a network of networks, such as the Internet. Any or all components of computer system 1500 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, and any other optical or magnetic media. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. In addition, a number of the figures (including FIGS. 2, 7, 8, and 11-14) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

1. A method for dynamically associating mobile devices with different logical networks implemented on a shared network fabric of an entity, wherein at least two different logical networks are implemented for at least two different groups of the entity, the method comprising:
at a first site of the entity:
authenticating a particular mobile device;
using a set of one or more mobile device management (MDM) servers to identify an MDM group with which the particular mobile device is associated;
using the identified MDM group to identify a first logical network that is defined over a shared network fabric at the first site for the particular mobile device to connect to network resources of the first site that are connected to the first logical network;
using the identified MDM group to identify a logical network identifier (LNI) associated with a second logical network connecting a first edge gateway at the first site to a second edge gateway at a second site of the entity; and
inserting the LNI in an encapsulation header that encapsulates data messages sent from the particular mobile device to a set of one or more network resources at the second site.

2. The method of claim 1, wherein the encapsulation header is a tunnel encapsulation header that is used to send the data messages from the first edge gateway to the second edge gateway through a tunnel established between the first and second edge gateways.

3. The method of claim 1, wherein the first logical network has an associated LNI and the first logical network LNI is the same as the second logical network LNI, as the first and second logical networks are one network.

4. The method of claim 1, wherein the first logical network has an associated LNI and the first logical network LNI is different than the second logical network LNI, as the first and second logical networks are two different logical networks with the first logical network being a logical local area network (LAN) and the second logical network being a logical wide area network (WAN).

5. The method of claim 4, wherein the encapsulation header is a first encapsulation header and the data messages are a first set of data messages, the method further comprising inserting the first logical network LNI in a second encapsulation header that encapsulates a second set of data messages sent from the particular mobile device to the network resources of the first site.

6. The method of claim 4, wherein using the set of MDM servers to identify the MDM group comprises receiving an MDM group identifier (ID) for the MDM group from the set of MDM servers

7. The method of claim 6, wherein:
using the identified MDM group to identify the first logical network further comprises determining that the MDM group ID is associated with the first logical network LNI, and
using the identified MDM group to identify the second logical network LNI associated with the second logical network further comprises determining that the MDM group ID is associated with the second logical network LNI.

8. The method of claim 1, wherein authenticating the particular mobile device comprises:
receiving a set of authentication credentials from the particular mobile device; and
using the set of authentication credentials to authenticate the particular mobile device.

9. The method of claim 8, wherein the set of authentication credentials comprises a username and password of a user of the particular mobile device.

10. The method of claim 8, wherein authenticating the particular mobile device comprises directing an authentication server operating at the first site to authenticate the particular mobile device.

11. The method of claim 8, wherein authenticating the particular mobile device comprises providing the set of authentication credentials to an authentication server operating at the second site to authenticate the particular mobile device.

12. The method of claim 1, wherein the network resources comprise one or more of servers, applications, middlebox services, and forwarding elements.

13. The method of claim 1, wherein the at least two different groups of the entity comprise different user groups of the entity.

14. The method of claim 1, wherein the at least two different groups of the entity comprise different device groups of the entity.

15. The method of claim 1, wherein using the set of MDM servers to identify the MDM group comprises providing a media access control (MAC) address of the particular mobile device to the set of MDM servers to identify a device group to which the particular mobile device belongs.

16. The method of claim 15, wherein the device group comprises devices of a same type.

17. The method of claim 16, wherein the same type is one of a laptop, smartphone, or tablet.

18. The method of claim 1, wherein using the set of MDM servers to identify the MDM group comprises providing a media access control (MAC) address of the particular mobile device and a set of authentication credentials associated with the user to the set of MDM servers to identify a user group to which a user of the particular mobile device belongs.

19. The method of claim 1, wherein the first site is a branch site of the entity and the second site is a cloud site of the entity.

20. A non-transitory machine readable medium storing a program for execution by at least one processing unit for dynamically associating mobile devices with different logical networks implemented on a shared network fabric of an entity, wherein at least two different logical networks are implemented for at least two different groups of the entity, the program comprising sets of instructions for:
at a first site of the entity:
authenticating a particular mobile device;
using a set of one or more mobile device management (MDM) servers to identify an MDM group with which the particular mobile device is associated;
using the identified MDM group to identify a first logical network that is defined over a shared network fabric at the first site for the particular mobile device to connect to network resources of the first site that are connected to the first logical network;
using the identified MDM group to identify a logical network identifier (LNI) associated with a second logical network connecting a first edge gateway at the first site to a second edge gateway at a second site of the entity; and
inserting the LNI in an encapsulation header that encapsulates data messages sent from the particular mobile device to a set of one or more network resources at the second site.
